(19) United States
(12) Patent Application Publication
(10) Pub. No.: US 2003/0212954 A1
(43) Pub. Date: Nov. 13, 2003

(54) Conceptual process redactor

(76) Inventor: Pilla Gurumurty Patrudu, Boston, MA (US)

Correspondence Address: PILLA G. PATRUDU, 132 TWIN OAKS VLG., MANSFIELD, MA, 02048, US

(21) Appl. No.: 10/319,167

(22) Filed: Dec. 14, 2002

Related U.S. Application Data
(60) Provisional application No. 60/341,361, filed on Dec. 17, 2001.

(51) Int. Cl. G06F 15/00

(52) U.S. Cl. 715/513

(57) ABSTRACT

Conceptual Process Redactor (CPR) is a method and system, for describing and translating conceptual descriptions of objects and their methods to OOPS object layouts and methods. CPR utilizes conceptual structures (C-structures or CPR classes), to describe information. C-structures are hierarchical information structures, and each hierarchical path is considered as a CPR data type. Thus, instead describing data in terms of OOPS data types, which are bound to storage layouts of the underlying machines, CPR describes data in terms of CPR data types, which may be regarded as concepts. The CPR translator, translates the CPR data types to their Oops equivalents by making use of Type Translation library, supplied with the CPR class description. CPR data types are unique within the class they are defined, and hence serve to identify the field as well describe a data type. Thus, a typical usage like Part quantity field of sales order header is now a data type in its own right, as well as a field. The uniqueness of the CPR data types is made use of in identifying the parameters of a method, if the context in which the method is invoked in known a priori. The CPR system provides a mechanism, called collaboration, to conceptualize process descriptions. As per collaboration, a group of objects may collaborate to accomplish a particular task (method). The collaboration serves as a context, and hence method invocations in CPR may omit the parameters, and these are identified from the collaboration. Each object acts as a client and the rest of the objects and temporary variables, act as servers. The client/server relationship is made use of by process descriptions called CPR Interface groups, which are specified for each of the collaboration objects, participating in the collaboration. In addition, to the intra object client/server relationship, objects are broadly classified as data sources or data containers, where the first form is considered as a sequential representation of data, and the latter form is considered as a random representation of data. Each data source may be grouped with zero or more data containers, and each such group is called a collaboration group. One or more collaboration groups may be specified in a table called the collaboration table, and collaboration groups with sequential group numbers are considered as a logical unit of execution. Thus, collaboration groups and the associated client/server relationship between the objects in the collaboration groups, may be used to conceptualize fairly complex method descriptions. The CPR translator will translate the process descriptions specified as CPR Interface groups for the collaboration objects into oops methods. The CPR runtime system provides necessary support to access/update the collaboration objects, and to invoke the oops methods generated during translation.

### CROSS-REFERENCE TO RELATED APPLICATIONS

This application is entitled to the benefit of Provisional Patent Application No. 60/341361 filed Dec. 17, 2001.

### BACKGROUND

1. Field of Invention

This invention is related to computer programming, specifically to object oriented programming constructs and functional language programming constructs.

2. Description of Prior Art

In the past few decades several programming languages and methodologies were invented, of which functional programming and object oriented programming (OOPS), methodologies received wide spread acclaim. Functional programming languages are often considered as 4^{th} generation programming languages or 4 GL's. Most of the popular OOPS languages like C++ and Java, are based on the “C” language, which is a well known 3 GL. Unfortunately, the development of OOPS programming constructs and functional language programming constructs went in different directions, and each of them failed to grasp the benefits of the other. The heavy demands of the software industry on reusability, made OOPS programming constructs extremely popular, even though the underlying programming methodology is based on a 3 GL, and require significant coding by developers. Functional languages provide a higher level of programming constructs, and reduce the coding effort significantly.

OOPS provides a kind of functional behavior, and many experts consider this as an equivalent and/or replacement for functional programming language constructs. My own research in both language constructs proved otherwise, and now I strongly believe that the functional behavior of OOPS languages cannot replace functional programming language constructs. Much of the confusion that prevails both in the industry and in research areas may be attributed to functional programming languages themselves. Although, functional programming languages started with humble beginning, they evolved quite rapidly, and many operations may now be regarded as functions, and can be brought under the functional programming language umbrella. Some striking examples are of course, the world famous functions like “sum”, “min” and “max” of SQL. Thus, functional programming language constructs did not become extinct, but have undergone some change and were absorbed in scripting languages.

OOPS is an extremely popular and powerful programming language mechanism. However, it failed to include the rich features of functional programming languages. For example, the simple “sum” function of SQL is innately beautiful and conceptualizes the entire operation. OOPS, provides mechanisms to accomplish the same feat, but due to the lack of conceptualization, these may appear as crude to a connoisseur of programming language constructs.

OOPS programming constructs, which were designed with reusability as central theme, were based on primitive data types. Although, complex custom data types maybe created from simple data types, these are intricately tied to the machine representation of the object layouts and barely correspond to human thinking. Functional programming language constructs are more akin to human thinking, but these lack the much desired object properties, like reusability and packaging. In addition, I have observed during my research that most functional language constructs are in plain vanilla format and lack the ability to absorb events. It maybe noted that event driven programming technique was made popular by modern operating systems, and this programming technique blends very well with OOPS programming constructs.

Thus, according to my research, an ideal mechanism to describe and process human thoughts must map data types to concepts, instead of physical storage layouts, and the processing will make use of high-level functional programming language constructs instead of 3 GL constructs. The feasibility and design of such a language mechanism was the topic of my research, and I was very surprised when I realized, that such a mechanism might be designed, with very little effort. My design to describe and process human thoughts as concepts is the subject of this patent application.

### SUMARY

The present invention aims at

1) Creating new data types called concepts, which are more akin to human thoughts.

2) Creating a new variant of functional programming language constructs called conceptual processing constructs, to describe processing in a form, which closely resembles human thoughts.

3) Translating the new data types (concepts), and the new language constructs (conceptual processing constructs), to OOPS programming constructs.

### OBJECTIVES AND ADVANTAGES

Several objectives and advantages of the present invention are

1. Conceptualization of object layouts

2. Conceptualization of method specifications

3. Elimination of coding

### DRAWING FIGURES

In the drawings, closely related figures have the same number but different alphabetic suffix.

FIG. 01 describes the CPR system.

FIG. 02 describes a C-structure

FIG. 03 describes a Sales Order C-structure

FIG. 04 describes the Physical mappings for the Sales order C-structure.

FIG. 05 describes a Sales order C-Structure

FIG. 06 describes a Formal definition of the CPR class

FIG. 06A describes the DTD of the CPR class

FIG. 06B describes an example for the CPR class definition

FIG. 07 describes the type Translation Library

FIG. 08 describes a Sample Type Translation Library

FIG. 09 describes the Translated OOPS classes

FIG. 10 describes a Sales order C-structure

FIG. 11 describes a Formal definition of the CPR List

FIG. 11A describes the DTD of the CPR List

FIG. 12 describes a Formal definition of the CPR Map

FIG. 12A describes the DTD of the CPR Map

FIG. 13 describes a Formal definition of the CPR DATA Group

FIG. 13A describes the DTD of the CPR DATA Group

FIG. 14 describes a Formal definition of the CPR Interface

FIG. 14A describes the DTD of the CPR Interface

FIG. 15 describes a Formal definition of the CPR Interface Group

FIG. 15A describes the DTD of the CPR Interface Group

FIG. 16 describes the layout of the Collaboration table

FIG. 17 describes a simplified Collaboration Table

FIG. 18A describes the scope of Collaboration

FIG. 18B describes the scope of Collaboration

FIG. 18C describes the scope of Collaboration

FIG. 19 describes the Temporary Variables Array Element Layout

FIG. 20 describes the Temporary Variables Symbol Table Layout

FIG. 21 describes the Formal definition of CPR Method

FIG. 21A describes the DTD of the CPR Method

FIG. 22 describes the Layout of the KEY_CTRL object

FIG. 23 describes the Layout of the DATA_GROUP_CTRL object

FIG. 24 describes the Layout of the DATA_GROUP_PROPERTIES object

FIG. 25 describes the CPR Data type combinations

FIG. 26 describes the Layout of the Ctable Object

FIG. 27 describes the Layout of the Ctable_entry Object

FIG. 28 describes the schematic for CPR Runtime Support.

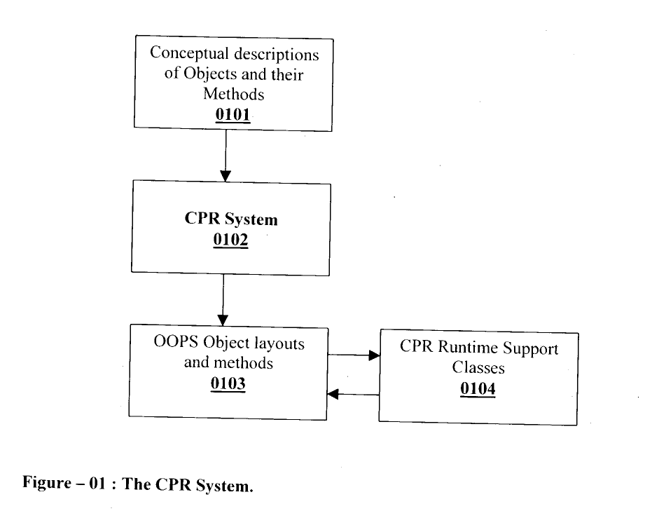

### DESCRIPTION—FIGS. 01 THRU 21A—PREFERRED EMBODIMENT

A preferred embodiment of the present invention is illustrated below with the help of FIGS. 01 thru 21. Conceptualizing human thoughts is a fairly complex process, and during my research I have invented several techniques to realize the objective. Since, most of my invention is new, and is not known in prior art (to the best of my knowledge), the description contains several sections, which introduce these newer concepts developed by me, and the associated terminology. The invention itself, grew out of several unrelated projects, and it took me several months to formalize and organize the content. In order to keep the description simple, I have taken the liberty to describe my invention in short sections, almost like a tutorial.

The mechanism to describe and process human concepts, is referred to as CPR (Conceptual Process Redactor), and comprises of, a language specification for describing the concepts, and a translator for converting the conceptual representations of object and method specifications into OOPS object layouts and method definitions. Needless to say, OOPS is chosen as the underlying base, as it is the most preferred and widely used methodology, in the software industry.

1) CPR-XML:

XML is a meta language created by W3C consortium, and has gained wide spread popularity. However, XML is very verbose, and is not ideally suited for describing attributes or fields and methods of Objects. The OOPS syntax for describing attributes or fields, and methods is concise, and is ideally suited for the purpose, however, readymade parsers are not available, and hence OOPS syntax notation may be extra burden to implementers. On the contrary, XML parsers are readily available, and a few good parsers are also available for free of cost.

In view of the above prevailing scenario. I have modified XML slightly, so that it is less verbose, and is more suited for describing attributes or fields and methods of Objects. The resulting specification is referred to as CPR-XML, and the description of CPR-XML is provided in Appendix-I. It maybe noted that, since CPR-XML is closely related XML, the readily available parsers can be modified slightly to suit the needs of CPR-XML.

2) CPR System:

FIG. 01, describes the CPR system 0102, which receives conceptual descriptions of objects and methods 0101 as input, and produces OOPS object layouts and methods 0103 as output.

3) C-Structures and CPR Data Types:

A C-Structure, is a conceptual representation of an information structure, in the form of a tree. Each node of the tree, is referred to as a conceptual tag. C-structures are often described as trees, in CPR-XML language. All the hierarchical paths from the root to the leaf nodes are considered as a description of the C-Structure, and each hierarchical path is referred to as a CPR data type. In CPR the data type uniquely identifies the attribute/field, hence a field name is usually not required, to identify a field of the C-Structure. This special property of CPR data types, enable us to refer field names by their respective data type names. C-Structures are also referred to as CPR classes.

A tag is an identifier, which begins with an alphabetic character, and is followed by zero or more alphabetic characters or numeric characters or the special character underscore (‘_’).

The conceptual tag is a sequence of tags, which are separated by ‘.’ (dot) characters. In addition, the first tag is prefixed with one or more special character sequences like ‘$’, ‘&’, ‘#’, ‘@’, ‘$$’, ‘/$’, ‘&&’, ‘!’, ‘!!’, ‘!!!’ and ‘//’. It maybe noted that the special character sequence list given here is not exhaustive.

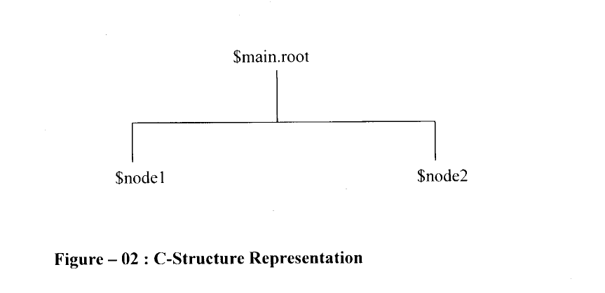

FIG. 02, depicts a sample C-Structure, where,

$main.root, $node-1 and $node-2 are conceptual tags and

$main.root.$node-1 is a hierarchical path.

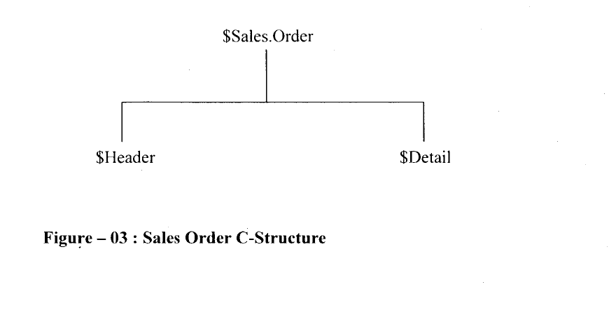

FIG. 03, represents a more realistic example, where,

$Sales.Order is the root conceptual tag, and conceptual tags $Header and $Detail are sub nodes or simply nodes.

$Sales.Order.$Header and

$Sales.Order.$Detail are hierarchical paths from the root.

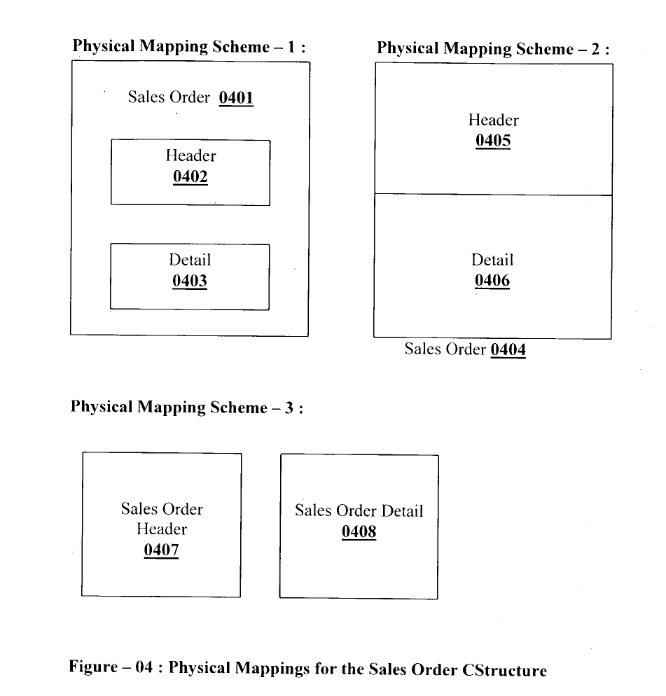

The C-Structure described in FIG. 03, is a logical structure and may have many physical representations. FIG. 04, depicts several physical mappings for the C-Structure in FIG. 03, and

3.1) As per the physical mapping scheme—01, $Sales.Order may be a physical object as depicted in 0401, which comprises of sub objects $Header 0402, and $Detail 0403.

3.2) As per the physical mapping scheme—02, $Sales.Order may be a physical object 0404, which comprises of logical partitions $Header 0405, and $Detail 0406.

3.3) As per the physical mapping scheme—03, $Sales.Order.Header 0407, and $Sales.Order.Detail 0408, may be separate objects, without an outer casing or container.

Thus, it may be noted that the logical description, such as the one given in FIG. 03, is more powerful than its counterparts given in FIG. 04, which are mapped to a physical layout, since the logical description conceptualizes the storage layout.

4) CPR Data Types—Examples:

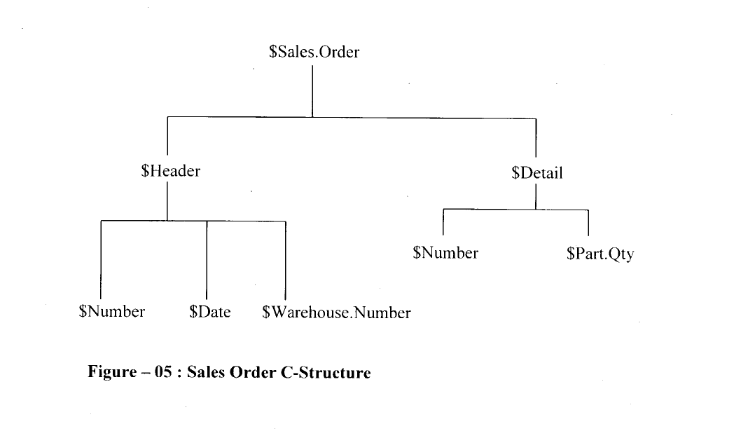

FIG. 05, depicts a Sales order C-Structure with attributes (fields), such as order number, order date and quantity. In order to illustrate the details of CPR data types, several important cases are examined, below

4.1) From FIG. 05, the “quantity” field of Sales order detail may be described, as

$Sales.Order.$Detail.$Part.Qty;

A moment of reflection, will manifest that “part quantity” is an attribute or field of the Sales Order Detail. However, quantity by itself is not an attribute or field of Part, since the Part object will only describe its attributes or fields, and not how many of them exists. In this case “Qty” is conceptually associated with “Part”.

4.2) From FIG. 05, the warehouse number field of the Sales order header may be described as

$Sales.Order.$Header.$Warehouse.$Number;

This is a simple case of containment, where Warehouse number, is defined elsewhere and is contained or stored in Sales order header. It may be noted that Warehouse number is an attribute or field of Sales order header, but it is not defined in Sales order header.

In order to distinguish the external definition, the conceptual tag is prefixed with a ‘/’ character, in addition to the usual ‘$’ character. Thus the CPR data type may now be written as

$Sales.Order.$Header./$Warehouse.$Number;

4.3) From FIG. 05, the Sales order number may be described as

$Sales.Order.$Header.$Number;

$Sales.Order.$Detail.$Number;

It maybe noted that in this case, the Sales order number is defined as an attribute of the Header as well as the Detail. In this case, it is advantageous to create a single conceptual type such as “$Order.Number”, and include it in both the header and detail C-structures, as shown below.

$Sales.Order.$Header./$Order.Number;

$Sales.Order.$Detail./$Order.Number;

5) CPR Data Types—Packaging:

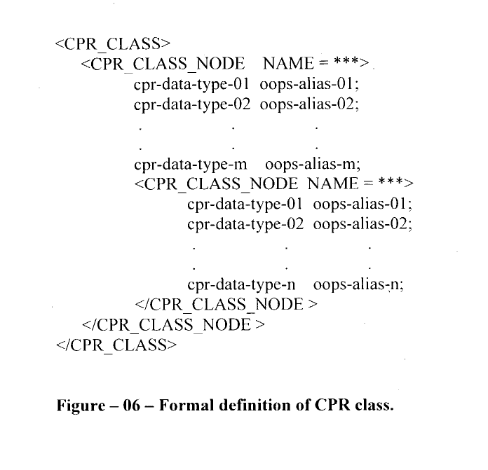

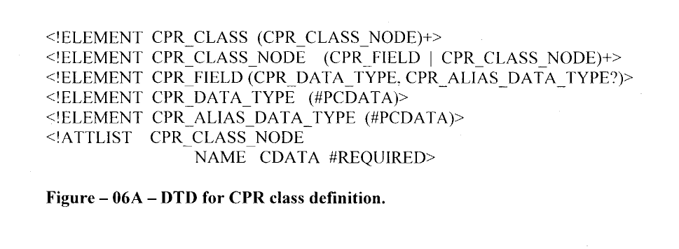

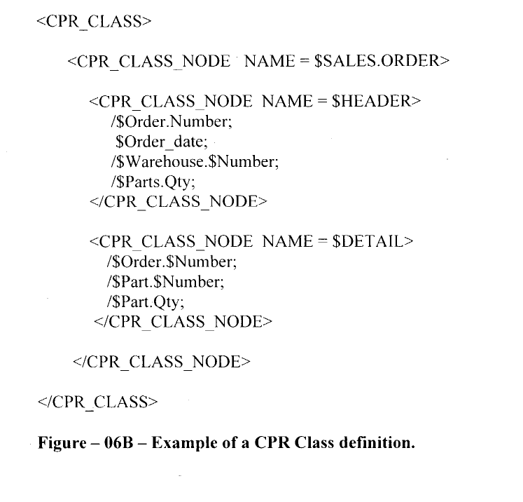

The definition and packaging of a C-Structure is depicted in FIG. 06, and resembles the OOPS class definition in some ways, but is expressed in CPR-XML. The DTD for a formal definition of the C-structure is depicted in FIG. 06A. The CPR data types of the attributes (fields) are obtained by concatenating the node names in the hierarchical path with the data type of the attributes. It may be noted that in CPR, the data types are unique, and hence the data types themselves maybe used to identify attributes or fields.

Thus, for the sample C_Structure given in FIG. 06B, the CPR data types of the attributes/fields of the CPR class may be given as

$Sales.Order.$Header./$Order.Number;

$Sales.Order.$Header.$Order_date;

$Sales.Order.$Header./$Warehouse.$Number;

$Sales.Order.$Header./$Parts.Qty;

$Sales.Order.$Detail./$Order.$Number;

$Sales.Order.$Detail./$Part.$Number;

$Sales.Order.$Detail./$Part.Qty;

6) CPR Data Types—Aliases: An alias may be defined for CPR data types of fields or parameters. Most often this is done to abbreviate the CPR data name with a short name. Another reason for setting up an alias is that, the alias may be used as an OOPS variable. An alias is written after the CPR data type, with one or more white space characters, between them.

For example, part qty in sales order detail may be represented as,

$Sales.Order.$Detail./$Part.Qty qty;

where, “qty” is the OOPS alias for part qty in sales order detail.

Every CPR data type corresponds to an OOPS data type. Sub components of an OOPS data type may be accessed via the OOPS dotted notation. Although, this is discouraged for custom data types like fields or attributes, this scheme is very useful in managing CPR system defined data types like index ranges, which are described later.

Aliases for CPR data types of C-Structure fields are automatically generated, when they are omitted, and the default notation uses the concatenation of “fld_nnnn_” and the last conceptual tag, where “nnnn” is a sequential number of the field number. It may be noted that the dot characters between the individual tags of the conceptual tag are separated by underscore characters, in the concatenation.

7) CPR Data Types—Simple Mapping:

The CPR data types such as $Sales.Order.$Header./$Order.Number, may be regarded as conceptual, since they are not mapped to storage, directly. In order to process these data types, the physical data type must be known, and the mapping of CPR data types to their physical counterparts (OOPS data types), is accomplished by making use of a registry called the CPR Type Translation Library.

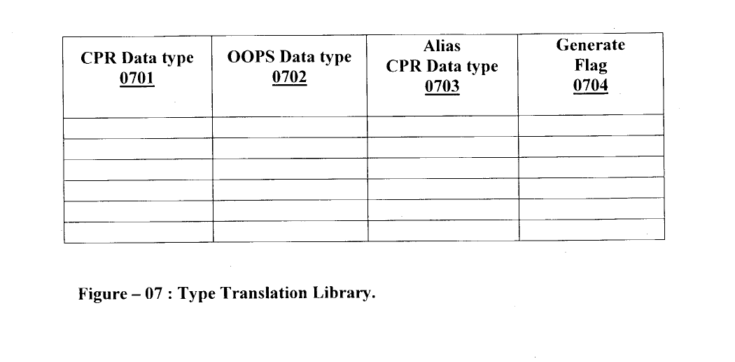

FIG. 07, depicts the CPR Type Translation Library, which is a large table, wherein the first column 0701 contains the CPR data types, and the second column 0702, contains the OOPS data types, and the third column 0703 contains the alias for the CPR data type 0701, and the fourth column 0704 contains a flag, and a value ‘Y’ in this column indicates that a separate oops class must be generated when the oops data type is encountered in a non containment form. The CPR alias data type 0703, is optional and may be left blank or set to null.

Thus by searching the CPR Type Translation Library for the CPR data type under consideration in column 0701, the corresponding OOPS data type and alias data type if any may be obtained from columns 0702, and 0703 respectively.

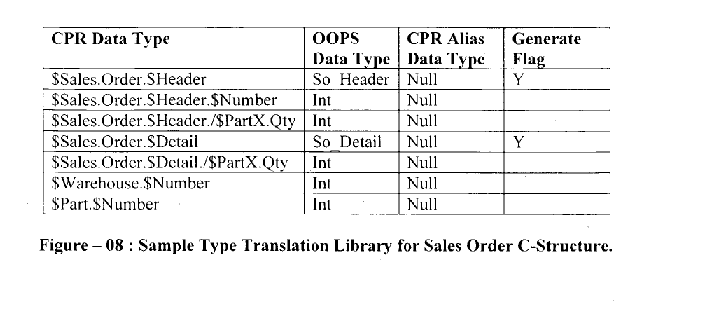

FIG. 08, depicts a few sample entries of the CPR Type Translation Library for the Sales Order C-Structure of FIG. 06B.

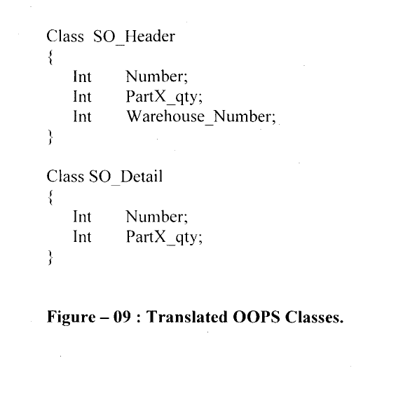

FIG. 09, depicts the OOPS classes that are created as a result of the mapping of the CPR data types of the Sales Order C-Structure of FIG. 06B, to OOPS data types.

The exact mechanism of the translation is described in the operation section. However, it may be noted that the mapping is a trivial operation, and can be accomplished by simple visual matching.

8) CPR Data Types—Inheritance:

CPR utilizes the same scheme as that of OOPS for specifying inheritance. The most popular keyword in OOPS language to signify inheritance is the “extends” keyword.

When C-structures or CPR classes result in more than one OOPS data type, after compilation, the CPR class must be further qualified with a partition name (sub node), to identify the specific OOPS class during inheritance.

9) CPR Data Types—Identification and Matching:

As explained above, CPR data types are unique and hence may be used as attributes or field names of the underlying C-Structure. During data access, CPR data types may be specified completely starting from the root, or partially, starting from a sub node of interest. In the former case, the CPR data types are pre bound and fully determined, where as in the latter they may be bound to the C-Structure, at the time of specification. Partial CPR data types are extremely useful for defining the parameters of methods, since these may be shared by more than one C-Structure, and the complete CPR data type is determined based on the C-Structure, which implements the method. It may be noted that the definition of methods may be shared by more than one object, and this feature is widely used in OOPS as interfaces.

For example, widely prevalent C-Structures like Sales Order and Invoice, may share a simple print method, which takes the Sales order number or invoice number as a parameter. Instead of fully defining the parameter as $Sales.Order.$Header.$Number, or $Invoice.$Header.$Number, it may be defined as *.$Number, so that the definition of the print method may be shared by both the C-Structures.

10) CPR Data Types—Arrays and Indexing:

The Sales order examples considered thus far are simplified approximations, however we often encounter situations in order processing, where the order details are in turn composed of multiple sizes, of the part. For example, nuts, bolts and screws of a particular type comprise a part, and the part in turn may have multiple sizes. Other common examples are shoes, apparel, toothpaste and soaps, as all these parts have multiple sizes.

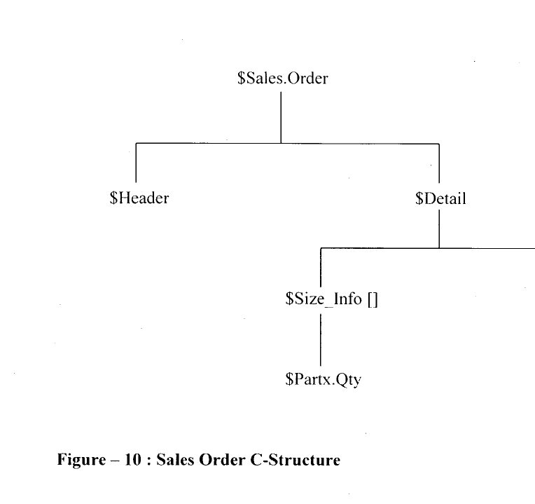

FIG. 10, depicts a Sales order C-Structure, where the detail is in turn made up of multiple sizes. The CPR data type for the part quantity in the sales order detail may now be described as

$Sales.Order.$Detail .$Size_Info[ ]./$Part.Qty;

where Size_info is declared as an array.

To access a particular item of an array, an index is needed, for which CPR provides a novel solution. The index of the above array may be represented by the CPR data type given below

cpr.dt.$Sales.Order.$Detail.#Size_Info;

In general, the conceptual tag where the array is defined is prefixed with ‘#’ instead of the usual ‘$’, and the resulting CPR data type defines the index for the original CPR data type. The OOPS data type of any CPR data type which has a ‘#’ prefix for one of its tags is always integer (int or long int, based on implementation).

This notation, simplifies various data processing concepts, and is widely used in CPR to conceptualize “for” loops.

11) CPR Data Types—Indexes—Special Considerations:

Indexes are one of the most frequently used CPR data types, and unlike attributes or fields of objects, these are not assigned storage within the object, but are stored outside of objects as temporary variables. Each index variable itself may be considered as an object with sub components (fields) within the object. A large number of special considerations apply to index variables, in order to make them easier to use, in processing. It may be noted that an index variable may be a single value or a range of values with start, end and increment as sub-components.

11.1) Index Value: The current value of an index or an index range may be referred to as the sub component $CPR_IDX_VAL. and my be represented as $cpr-index-data-type/$CPR_IDX_VAL.

11.2) Sub-Components: The sub components (fields) of an index range, may be referred to as, CPR_IDX_START. CPR_IDX_END, and CPR_IDX_INC.

In CPR terms, these sub components may be described formally as

$cpr-data-type./$CPR_IDX_START;

$cpr-data-type./$CPR_IDX_END;

$cpr-data-type./$CPR_IDX_INC;

The sub components described above are with respect to CPR notation. Hence, any component of an index range may be used as a valid data type as a parameter or return type of a CPR method.

11.3) A method may return an index range or a single value of an index. In the former case, the conceptual tag is prefixed with ‘##’ prefix, at the index position. In contrast, when a single index value is returned by a method the conceptual tag is prefixed with ‘#’, at the index position as described previously.

It may be noted that both index ranges and single value indexes are treated as indexes and match a parameter with a single ‘#’ as prefix. This concept is explained again in a later section.

11.4) An index range is considered as an abbreviation for a “for loop”, and the loop is executed form the start value, until the end value, in steps specified by the increment value. This is a crucial and most important design aspect of CPR.

11.5) An index value may be paired with a sentinel. Typically the sentinel has the same CPR data type name as that of the index. but the conceptual tag is prefixed with ‘/#’. Since, a range index may be considered as a “for loop”, the sentinel maybe used to limit the range of the loop, and acts as an “end for” statement.

Let us reconsider the example given before for a simple index, where an array and index are represented in CPR as

$Sales.Order.$Detail.$Size_Info[ ];//array definition

$Sales.Order.$Detail.#Size_Info;//index specification

Assume that this CPR data type is returned by some method, say XYZ, then the specification, $Sales.Order.$Detail.#Size_Info, is ambiguous, since the method may return a single index value or an index range.

The signature of the method XYZ may be given in OOPS form (non XML) as

$Sales.Order.$Detail.#Size_Info XYZ(void);//ret single index val

—or—

$Sales.Order.$Detail.##Size_Info XYZ(void);//ret index range

It may be noted that both return types

$Sales.Order.$Detail.#Size_Info and

$Sales.Order.$Detail.##Size_Info match the CPR data type

$Sales.Order.$Detail.#Size_Info.

When a CPR data type representing an index and its sentinel are written in order, they may be regarded as a “for loop”, if the CPR data type is an index range. If the CPR data type is a single value index, the corresponding sentinel becomes a no operation and is ignored.

1 11.6) An INDEX_RANGE is a CPR system object, and its OOPS components may be accessed via an alias, in an expression. The components of an index range are represented by the tupule <x, y, z>, where x is the start value, y is the end value and z is the increment.

Thus, when a CPR data type is aliased as shown below.

$Sales.Order.$Detail.#Size_Info idx;//index specification

The individual components of indexes may be accessed as idx.x, idx.y, and idx.z in expressions.

12) CPR Data Types—Type Casting:

Type casting of CPR data types, is an extremely important feature and a separate section is devoted due to its importance.

Type casting is also described as a CPR function in the section on CPR functions.

When a CPR data type or OOPS data type or the result of an expression, is type casted into another CPR data type, then the following procedure is followed.

12.1) If the CPR data type or OOPS data type is being created (results of expressions are always considered as being created), then the newly created variable is defined with the CPR data type specified in the type cast operator.

12.2) If the CPR data type already exists as an attribute/field of an object or as a temporary variable, then a new copy of the field or temporary variable is created with the CPR data type specified in the type cast operator. In this case, the type cast operator functions as an assignment operator. This behavior is unique to CPR, and is not known in OOPS.

13) CPR Data Types—Symbolic Values:

The values of an attribute or field may be assigned symbolic names. For example, the Sales Order C-Structure considered before, may contain an attribute or field called status, which may take, ‘O’ (open). ‘C’ (closed), or ‘S’ (shipped) as values.

The CPR data type for status may be defined as

$Sales.Order.$Header.$Status;

The values for the status field may be described, in terms of symbolic names as

$Sales.Order.$Header.$Status.&Open ‘O’;

$Sales.Order.$Header.$Status.&Closed ‘C’;

$Sales.Order.$Header.$Status.&Shipped ‘S’;

In general, the conceptual tag for the symbolic name begins with an ‘&’, instead of the regular ‘$’ character.

A group of values may be assigned a symbolic name as described below.

cpr.dt.$Sales.Order.$Header.$Status.&Closed_or_Shipped ‘C’, ‘S’;

The following illustrates a more complex example, where the Sales order header is considered to contain the ship date. The CPR data type for the ship date may be given as

$Sales.Order.$Header.$Ship_date;

Since, ship date is a date object its values must be enclosed in ‘{’ and ‘}’ characters. The January ship dates may be described in terms of symbolic constants as

cpr.dt.$Sales.Order.$Header.$Ship_date.&Jan_Ship_dates

{01, 01, 02}: {01, 31, 02);

It may be noted that the range of dates is separated by a ‘:’ character.

Symbolic constants described so far are not uncommon in prior art. In fact, both the “C” language and COBOL provide mechanisms for defining symbolic constants.

CPR extends the symbolic naming scheme to assign values to index variables. For example, as described before, the Size_Info of a Sales order detail maybe written as

$Sales.Order.$Detail.$Size_Info[ ]./$Part.Qty;

The index variable, for the above CPR data type may be described in CPR as

$Sales.Order.$Detail.#Size_Info;

In CPR, symbolic names may be assigned to values of index variables.

Hence, the first item may be described as

$Sales.Order.$Detail.#Size_Info.&First_Item 0;

Although, an index variable may contain only an integer value, the symbolic names may be assigned either integer values or INDEX_RANGE object values.

In view of the above, preferred sizes may be described as

$Sales.Order.$Detail.#Size_Info.&Preferred_Sizes {3, 7, 1};

where, the value {3, 7, 1} is treated as an INDEX_RANGE object, with 3 as the starting value, 7 as the ending value and 1 as the increment.

Symbolic names for Index variables are extremely useful, and are extensively used in later sections of the description.

14) CPR Data Types—Special Data Types:

CPR provides Special data types to represent well known entities like Integers, Floating point numbers, and character sets. The examples provided below manifest the scope and usage of these special data types.

$CPR.DT.$INT represents integers, and individual integers may be described using the symbolic constant notation as described below.

$CPR.DT.$INT.&V1 (value 1),

$CPR.DT.$INT.&V256 (value 256),

$CPR.DT.$INT.&V−300 (value −300).

Similarly, $CPR.DT.$FLOAT represents floating point numbers, and individual floating point numbers, may be described using the symbolic constant notation as described below.

$CPR.DT.$FLOAT.&V1.01 (value 1.01)

$CPR.DT.$FLOAT.&V−234.77 (value −234.77)

Similarly, $CPR.DT.$ASCII.CHAR represents character values in the underlying character set, and individual values, may be described using the symbolic constant notation as described below.

$CPR.DT.$ASCII.CHAR.&VA (value ‘A’)

$CPR.DT.$ASCII.CHAR.&Va (value ‘a’)

$CPR.DT.$ASCII.CHAR.&VX054 (value represented by hex ‘054’)

Besides, the above special data types, which represent the popular OOPS data types, there are few more special data types in CPR which are extremely useful, and are described below.

$CPR.DT is a special data type, which is extremely useful for evaluating expressions, and for specifying generic functions, which are not tied to CPR data types.

$CPR.DT.$OOPS is a special data type, which is extremely useful to break out of CPR mode, and break into OOPS mode. Thus. OOPS method calls may be specified simply by prefixing the method call with $CPR.DT.$OOPS. The parameters of the oops method may still use CPR data types. An example is provided below to illustrate this concept.

$CPR.DT.$OOPS.My-oops-class.sample-oops-method ($Sales.Order.$Header./$Part.Qty, oops-parm, 123, 456.78, ‘A’, “$XYZ”);

It may be noted that the first parameter is a CPR data type, and the second is an oops alias for a CPR data type, and the rest are int, float, chat and string data types.

$CPR.DT.$INTF is a special data type and may be used to define an interface name, as described below.

$CPR.DT.$INTF.$cpr-intf-name;

15) CPR Data Types—Patterns:

Symbolic constants explained above are extremely useful in processing. Although symbolic constants may be grouped to form a list, this mechanism may not be suitable when the number of values enumerated is extremely large. In order to overcome this limitation patterns are provided.

Patterns describe the contents of a CPR data type as regular expressions, which are extremely popular with Unix scripting languages. Besides, it is possible to mix these regular expressions with CPR data types as described below.

{[“reg-ex”] [cpr-data-type] [“reg-ex”]}

where, one or more white space characters may separate regular expressions and cpr data types. The same principle, holds true for the data components they represent.

Thus, regular expressions and CPR data types may be intermixed in any order. Each CPR data type is considered as a pattern, and is described by the “I/O” format of the corresponding OOPS data type, in the “C” language. In other words, if the CPR data type corresponds to an “int”, “float” or “string” data type in OOPS, then the pattern is given as “%d”, “%f” or “%s”. Conversely, patterns may be used to break a CPR data type into constituent data types.

Before, introducing complex patterns, a simple example is presented to illustrate the requirement for complex patterns.

Often one or more comment fields are stored for various records/documents/objects such as sales orders. These comments are usually notes or reminders, which are created by the sales teams, while interacting with their clients. Some times, the information entered in these highly unstructured string fields is needed for processing the sales order.

Patterns are extremely suitable in these cases. However, since there may be more than one comment line, it is possible to have more than one pattern for the same field. Thus, the requirement for multiple patterns was born.

When more than one pattern is specified for a CPR data type, then it is necessary to identify the pattern which is associated with the data of the CPR data type. This is accomplished by storing a prefix in the data and the pattern.

Thus the pattern may now be represented as

{“prefix:”[“reg-ex”] [cpr-data-type] [“reg-ex”]}

Besides, regular expressions described above, patterns may also hold mini programs in a simplified language made of arithmetic, relational and logical operators. The mini language is described in Appendix—2.

It is important to note that when the pattern is a regular expression, the value represented by the CPR data type, is searched for the pattern. If the pattern is an expression, then a value may be created as an internal variable represented by the CPR data type. If the pattern is a mini program, then several CPR data type fields may be affected, after its execution.

16) CPR Data Types—Formats:

The print format of a CPR data type may be specified as a tag which follows the CPR data type. The “C” language specification is slightly modified to suit the requirements of CPR.

In “C” language the print format of a variable maybe specified as “%7d” and “%7.2f”. CPR uses this concept, and equivalent definitions in CPR may be given in “Width-Decimal point” or “W-D” format as, “%%W7” and “%%W7D2”.

17) CPR Data Types—Introduction to Predefined Data Types:

CPR provides a few predefined data types to simplify processing. Most of these predefined data types represent, lists, maps and other common data types. These data types are explained in detail in a later section. It is important to note that the predefined CPR data types are customizable. The brief explanation provided here merely fills the gap, as these are referred in the next section.

18) CPR Data Types—Extensions:

In OOPS, a field name representing an object may be followed by a method name as described below

object-name.method-name( );

Unlike OOPS, method invocations in CPR are not followed by the parameter list. Thus, method names themselves can be considered as conceptual tags.

CPR identifies the parameters required by the method, and this scheme is explained in greater detail in a later section. The benefits of treating method names as conceptual tags will become clear, in later sections.

Besides method names, predefined entities like lists or maps, formats, and patterns may follow a CPR data type name. All these discrete entities are collectively referred to as CPR extensions.

The syntax for CPR extensions is as follows

Methods are prefixed with ‘$$’,

Predefined CPR entities are prefixed with ‘//’.

Formats are prefixed with ‘%%’,

Patterns are prefixed with ‘&&’

It may be noted that, CPR extension is an optional feature of the CPR data type, and may be omitted.

19) CPR Data types—A Simplified Introduction to Collaboration:

CPR utilizes an innovative mechanism called “Collaboration”. This concept is briefly introduced here, as it is referred in the next section, while the complete description of “Collaboration” is deferred till later sections.

In simple terms, the Collaboration principle states that a group of objects collaborate to accomplish a particular task. Thus, the parameters of a method may be identified from the attributes/fields of the other objects, and the temporary variables created thus far, which are collectively referred to as the collaboration. The object to which the method belongs is called the client, and the other objects, temporary variables, in the collaboration are referred to as servers.

20) CPR Data Types—Introduction to Functions:

CPR introduces a novel concept called functions. Functions are widely known in prior art, however there are significant differences between the prior art and my invention. In more exact terms, the term function is chosen in CPR for lack of a better term to describe the process mechanism.

In languages like “C”, JAVA, and LISP (prior art), functions are represented as

f(x, y);

where “f” is the function, “x” and “y” are arguments.

It may be noted that in most languages of prior art, the terms function and method are synonymous, and are interchangeably used to describe an operation. Scientific, functions like “sin”, “cos”, and “tan” of an angle are also referred to as functions in prior art. It maybe noted that irrespective of the terminology used, both functions and methods of prior art, act upon their arguments.

In CPR, functions and methods are different entities and serve different purposes. Hence, the notation f(x,y), in CPR means that “f” is a method, and the arguments “x” and “y” are CPR data types.

From a notation standpoint, the CPR function begins with an ‘@’ character, and follows the CPR data type described before.

Unlike functions known in prior art, which act upon their arguments, CPR functions can act upon the argument, and some other entity. The argument is referred to as client, and the other entity is referred to as server. The other entity is inferred from the Collaboration, by making use of the CPR data type Identification and Matching scheme described previously.

CPR functions are not limited to the Client-Server role described above, and may be used like regular functions known in prior art. In this type of usage, the CPR functions are often used for searching a list of values, using a field or a symbolic constant.

An extremely simplified example is provided here to illustrate the CPR functions. It is assumed that it is required to generate a purchase order from the sales orders available. In this case, the Part quantity specified on the sales orders must be added to get the total quantity.

The definition of the Part quantity in the Sales Order and Purchase order C-Structures may be given as

$Sales.Order.$Detail.$Size_Info[ ]./$Part.Qty;

$Purchase.Order.$Detail.$Size_Info[ ]./$Part.Qty;

The required addition may be represented as a CPR data type given below

*.$Part.Qty.@CP_Add;

It may be noted that there are too many missing pieces to complete the example, at this time, but as we progress further, the missing pieces will become evident.

CPR Functions are described in full detail in a later section.

21) CPR Data Types—Generalized Format:

The generalized format for the CPR data type may be given as

First-Conceptual-tag[.Conceptual-tag][.extension][.CPR-Function] alias;

It may be noted that the high level Conceptual tags may be omitted, when the CPR data type is used as a method parameter. In these case, the CPR data type may be described as

*.Conceptual-tag[.Conceptual-tag][.extension][.CPR-Function] alias;

CPR data types described thus far, fulfill the objective #1, outlined in the “Objectives and Advantages” section of this document.

22) CPR Data Types—Predefined Data Types:

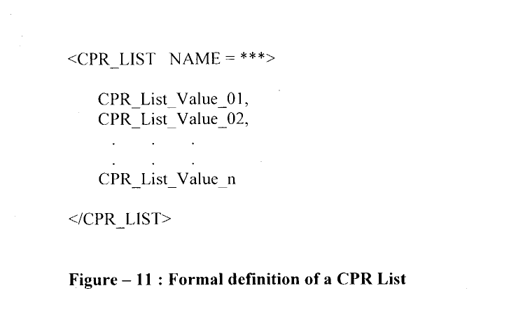

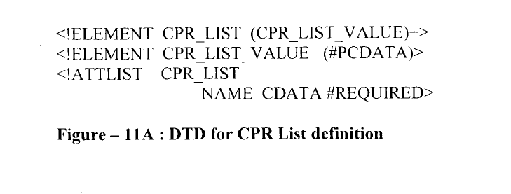

22.1) Lists: A list is a collection of all possible values, a data type may represent. Partial lists are proper subsets of lists and are widely used in processing. Symbolic constants can provide the same feature, and may be regarded as lists, however they may be defined only for attributes or fields of an object. Lists can store values of multiple fields, which are of different data types. However only primitive data types and a few established objects like Date values may be stored in the lists. In order to simplify processing of lists, the list elements must be specified as generic objects, where the underlying object is a wrapper over the primitive data type. This feature is often used in OOPS and objects such as Integer, Float, and Char are well-established wrappers over the primitive types, and all of them can be generically referred to as “Object”. FIG. 11 depicts the formal definition of a list. FIG. 11A depicts the DTD for a formal definition of the CPR List.

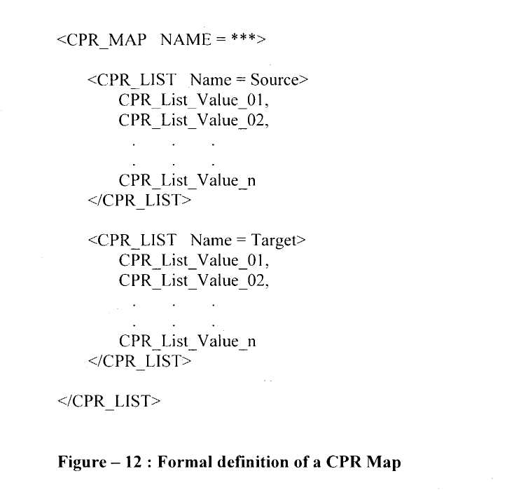

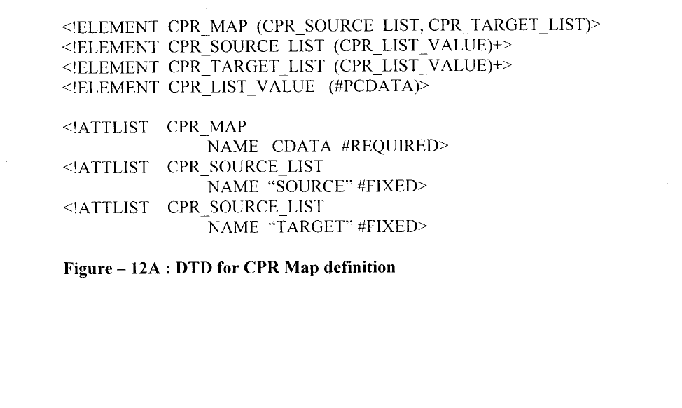

22.2) MAPS: A Map describes a simple one to one relation between two lists. FIG. 12, describes the formal definition of a map. FIG. 12A depicts the DTD for a formal definition of the CPR MAP. It may be noted that both lists participating in the map, must have the same number of elements.

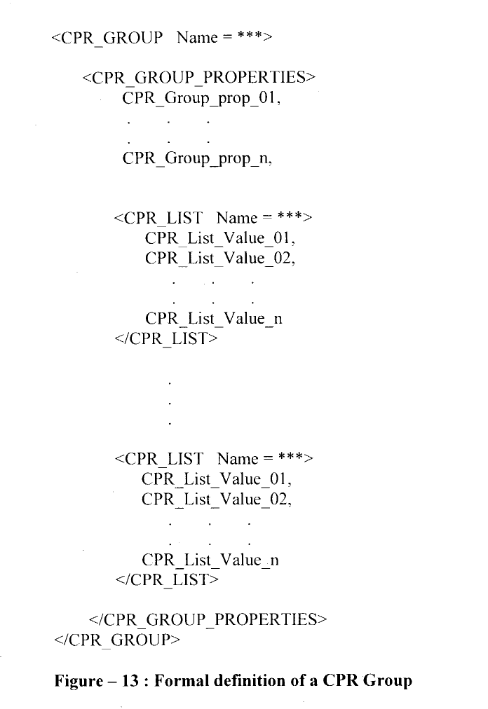

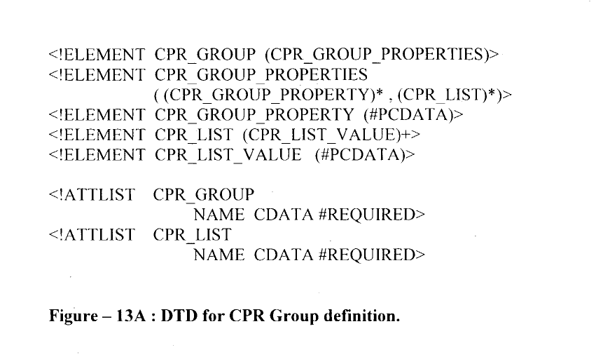

22.3) DATA GROUPS: A data group is one or more records, where some of the fields, referred to as Key fields, have identical values, or belong to a predefined list. FIG. 13, depicts the formal definition of a Data Group. FIG. 13A depicts the DTD for a formal definition of the CPR Data Group.

Groups, which are defined on the key equality basis, are referred to as “Homogenous Groups”. Often, grouping is also performed on non-homogenous key values, and such data groups are referred to as “Non Homogenous Groups”. It may be noted that the non homogenous group definition requires the specification of at least one list.

The default properties of homogenous group are null. At this time there are no other properties for the homogenous groups.

The properties of Non homogenous groups along with a few examples on their usage are provided below.

Assume that it is required to process a Transaction file. It is assumed that the Transaction code is contained as a field in the Transaction file. While most of the transactions are represented by a single transaction code. Often, we counter situations in processing, where transfer transactions are created as two separate transactions, which are physically next to each other.

In the example, it is assumed that the transaction codes maybe ‘01’ thru ‘20’, and the transaction code pairs, ‘03’, ‘04’ and ‘11’, ‘12’ are considered to be transfer transactions which must be processed as a data group.

In this case, a non homogenous group may be created for the transaction code pairs, ‘03’, ‘04’ and ‘11’, 12’, where the transaction code pairs are represented as Lists.

It is important to observe, that in the present example, the non homogenous group is required to have the property, where the existence of both transaction codes of a pair, defined as a list, is mandatory. In other words, if we receive a transaction with transaction code ‘03’, and if it is not followed by a transaction with transaction code ‘04’, then the previous transaction is in a state of error. Similarly, transactions with transaction code ‘04’ must be preceded by a transaction with transaction code ‘03’.

Thus, the properties of non homogenous groups may be generalized as explained below.

All entries must appear in the same order as that of the list, exactly once.

All entries must appear in the same order as that of the list, zero or once.

All entries must appear in the same order as that of the list, one or more times.

All entries must appear in the same order as that of the list, zero or more times.

Entries of the list may appear in any order, but exactly once.

Entries of the list may appear in any order, zero or once.

Entries of the list may appear in any order, one or more times.

Entries of the list may appear in any order, zero or more times.

The default property of the non homogenous group is “All entries must appear in the same order as that of the list, exactly once”.

23) Conceptual Processing—Conceptual Data Types (CDT's):

Even though the CPR data types described above are conceptualizations of Information structures, they are real data types, since they may be mapped to OOPS data types, which have a physical storage mapping.

Besides, the CPR data types, described thus far, the CPR system defines and uses a special class of innovative data types called “Conceptual Data Types” or CDT's. Unlike CPR data types, which are real, CDT's are imaginary, and only exist in the minds of the designers and developers.

CDT's were invented to simplify process specification. During my research, I have noticed that data in general has two important properties. The first property is related to its physical representation, and is known as data type in prior art, and the second property is related to how it may be used in processing. OOPS (prior art) has very little or nothing to offer to implement the second property. However, XML tags (prior art) may be used to describe the second property mentioned above. In CPR, the second property is implemented as the conceptual data type or CDT. It may be noted that CDT's may even be applied to methods.

CDT's are represented by a tag with a ‘@’ prefix. It may be noted that the representation is very similar to CPR functions, and this is design by choice. However, it is fairly easy to distinguish the two entities since, functions are represented as @CPR_function-name, where as CDT's are represented as @CPR_CDT_name. The similarity is exploited and a CDT may be specified via the type casting mechanism (@CPR_CDT_name) or the CPR function specification scheme as $cpr-data-type.@CP_CDT_name. Thus, a CPR function acting on a CPR data type, may create a new CPR data type with a CDT ending, and this newly created CPR data type will match a CPR data type which is type casted with the corresponding CDT.

CDT's may be classified into two types as CDT's for Methods and CDT's for attributes or fields. It may be noted that this classification is not a strict classification and CPR data types, may be treated either as pure data, or as methods, and hence can be typed either ways.

23.1) CDT's for Methods: There are no CDT's applicable to methods at this time. However, the design is flexible, and anticipates CDT's for methods in future.

23.2) CDT's for attributes or fields:

As explained before, CPR data types may be matched to similar data types in other C-Structures. For example, while a data type such as “x” can match “x”, it need not be a match for “Σ x”, where Σ is the universal summation symbol.

The above concept is of paramount importance, since on one hand we can add $Part.Qty of Sales Order Detail to $Part.Qty of Sales Order Header, whereas once a summation on $Part.Qty of Sales Order Detail is created outside, it cannot be assigned to $Part.Qty of Sales Order Header, without typecasting, or a similar mechanism like creating a data type alias. It maybe noted that $Part.Qty of Sales order header may be assigned an alias in the Type Translation Library as “$Part.Qty.@CPR_CDT_TOT”, and in this case a summation on the $Part.Qty of Sales Order Detail maybe assigned to $Part.Qty of Sales Order Header. Alternatively, $Part.QTY of Sales order header maybe type casted with the CDT @CPR_CDT_TOT, to match the total produced from the details.

The various conceptual data types (CDT's) applicable to attributes or fields are described below, along with a brief description. Since. CPR data types participate in a Client-Server relationship during Collaboration, the CDT specified for a parameter may be applied to the Client or Server. The default applicability is also provided for each of the CDT's.

23.2.1) @CPR_CDT_COUNT/TOT/AVG/MIN/MAX: These CDT's may be used to classify an attribute or field as the recipient of a count, total, average, minimum, or maximum of the underlying attribute, in a data group. These CDT's are applied to the client side by default.

23.2.2) @CPR_CDT_GCOUNT/GTOT/GAVG/GMIN/GMAX: These CDT's may be used to classify an attribute or field as the recipient of grand totals of the underlying attribute, in a data group. These CDT's are applied to the client side by default

24) Conceptual Processing—CPR Interfaces:

CPR provides an innovative mechanism called CPR Interfaces. A CPR Interface comprises of a sequence of CPR data types. Since, CPR data types may represent either data or methods, CPR Interfaces, which contain parameters that represent only data, are referred to as “Data Interfaces”, whereas CPR Interfaces, which contain parameters that represent both data and methods or only methods, are referred to as “Process Interfaces”.

CPR Interfaces are coded as XML documents, using the CPR-XML scheme. It may be noted that, CPR interfaces may also be coded as OOPS method signatures. Although, the syntax for describing a CPR Interface may vary, the semantics are governed by the CPR system design, and is the subject matter of this patent document.

The representation and packaging of CPR Interfaces is described in the next section.

24.1) Data Interfaces: The parameters of data interfaces, comprise of CPR data types, without methods. However, these CPR data types can still contain CPR functions. Those Data Interfaces, whose parameters, do not contain CPR functions are called “Pure Data Interfaces”, whereas those which contain CPR functions are called “Functional Data Interfaces”.

24.1.1) Pure Data Interfaces: The properties and interpretation of the parameters of a pure data interface are as described below:

24.1.1.1) Each CPR data type specified as a parameter in the pure data interface, must exist in the object definition, for which the interface is defined.

24.1.1.2) Each CPR data type specified as a parameter in the pure data interface, is translated to a “set” method of the attribute or field of the object.

24.1.1.3) The source of the data for the “set” method specified above, is determined from the collaboration.

24.1.2) Functional Data Interfaces: The properties and interpretation of the parameters of a pure data interface are as described below:

24.1.2.1) CPR data types, which are specified without a CPR function, are processed exactly as their counter parts in Pure data interfaces.

24.1.2.2) For those CPR data types, which are specified with a CPR function, the client and the server operands are identified and processed by the CPR function, and the result is fed to the “set” method of the object (client).

24.2) Process Interfaces CPR Interfaces are referred to as Processing interfaces, when they are not pure or functional interfaces. Typically, these interfaces contain more CPR data types, which perform conditional processing or “for loops”. The interpretation of the processing interface is usually complex and is based on the presence of various CPR functions described later.

25) Conceptual Processing—Packaging CPR Interfaces:

CPR Interfaces share a lot of commonality with OOPS methods, and replace these methods for most of the processing needs. It may be noted that one of the objectives of CPR is to eliminate coding, and CPR Interfaces accomplish this via the Collaboration scheme. CPR Interfaces are segregated form the object definition, and are packaged separately, for greater reuse.

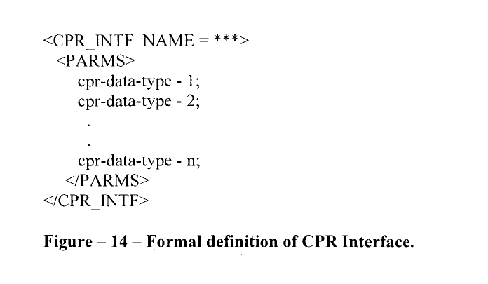

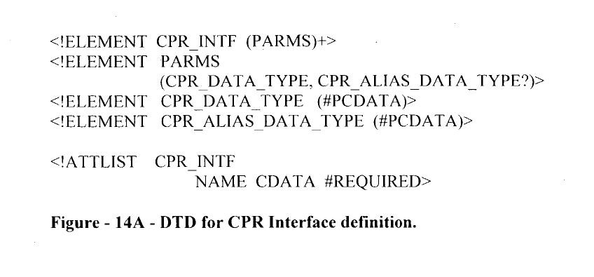

FIG. 14, depicts a formal definition of the CPR Interface. FIG. 14A depicts the DTD for a formal definition of the CPR Interface.

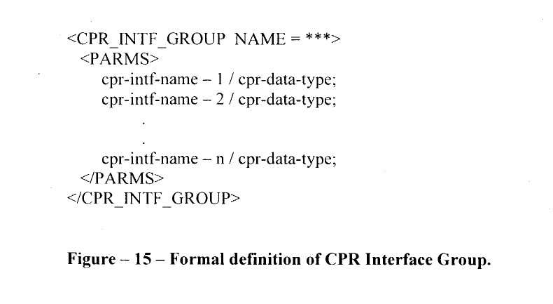

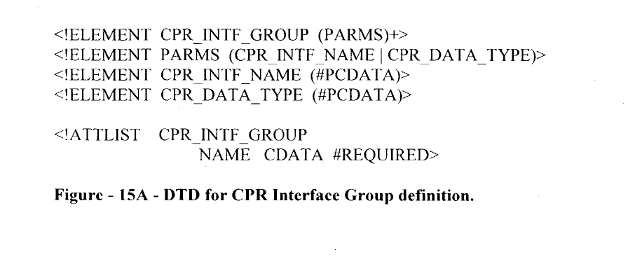

A group of related CPR Interface definitions are stored together as a CPR Interface group. FIG. 15 depicts the formal definition of a CPR Interface Group. FIG. 15A depicts the DTD for a formal definition of the CPR Interface Group.

The properties and packaging details of CPR Interfaces and CPR Interface groups are provided below.

25.1) CPR Interface name and CPR Interface group name comprises of a single tag, which is prefixed with a ‘$’ character.

25.2) Each CPR Interface is assigned a unique identification number within the CPR Interface group.

25.3) There may be at most one CPR Interface definition, if it includes data groups, and the CPR Interface definition, may not be enclosed in any conditional CPR data types.

The first parameter of a CPR Interface must be a data group, if data group operations are desired. The Key fields must be specified immediately after the specification of the data group.

25.4) CPR Interface group definition, resembles that of CPR Interface, and maybe enclosed in conditional CPR data types, to exclude the processing of some of the CPR Interfaces, based on the state of the objects, and the status of execution of the CPR Interfaces, which completed execution.

25.5) Each CPR Interface group is translated as an OOPS class, and each CPR Interface is translated into a method of the class.

25.6) Each CPR Interface returns an integer as status, and this status is stored in the OOPS class for the CPR Interface group. A separate status field is stored in the CPR Interface group to hold the CPR Interface group status.

25.7) Each CPR Interface stores upto 32 status codes, where each status code corresponds to the status of an action at that level. It may be noted that CPR data types may be nested upto 32 levels, and this level may be increased, if necessary by changing the invocation settings for the CPR compiler. The status codes are stored as an integer array within the method.

The translation of the CPR Group interface to OOPS class is described in the operation section.

26) CPR Data Types—Interface Templates:

OOPS provides an excellent mechanism called Interfaces to invoke methods of a large number of discrete objects in a generic way. CPR provides a similar feature and this generic scheme is called an Interface Template, which is a list of method names. However, Interface templates in CPR list only the method names, and their signatures are not required.

The readers would have noted a redefinition of traditional OOPS concepts. This became necessary, since CPR has to be closer to human thinking and hence it had to take into consideration the linguistic aspects of the keywords used.

The following simple table illustrates the difference.

| Keyword | CPR | OOPS |
|---|---|---|
| Interface | Implementation of a Method or | A Collection of Method |
| | process specification. | Signatures. |
| Interface | A Collection of Method Names, | N/A |
| Template | signatures are not required. Wild | |
| | card characters are allowed in the | |
| | name. | |

The CPR Interface template definition, lets designers and implementers agree upon a convention, and follow the convention. It may be noted that method overloading is detrimental to CPR, since CPR attempts to identify the methods parameters automatically, before making the call. The CPR system is at crossroads, when overloaded methods are specified in CPR data types, sine it may not be able to determine which method to invoke. CPR Interface Templates are an excellent solution to the above problem.

The design behind CPR Interface templates states that a protocol can be created, by reserving a subset of the name space, which is available to method names in a class, and by imposing restrictions upon usage of the reserved name space. The subset of the name space may be created by a regular expression, or by enumerating all the method names in succession.

It may be noted that although CPR Interface templates are merely protocols, they are more powerful than their OOPS counterparts, since any method name which has the string “read” as a prefix, may be inferred as some type of read operation.

For example, overloads of a method name “XYZ” may be enumerated as “XYZ1”, “XYZ2”, and “XYZ3”. The Interface template may specify all these methods with a single regular expression as “XYZ[1-3”.

Interface templates are considered as advanced features of CPR, and are not fully described in this application, as it can bring in many folds of complexity, into this application.

The brief introduction given here, is sufficient to illustrate that power of CPR and to ensure that it has the capability to progress into the more complex domains of human thought processes, not addressed by any language mechanism known thus far, in prior art.

27) Conceptual Processing—Collaboration Principle—Detailed Explanation:

CPR utilizes the Collaboration principle, to conceptualize the processing details of a method. Collaboration was introduced before in simplified terms, however in more exact terms, the Collaboration principle states that,

“The return type of the method, the parameters received by the method, and the attributes or fields of the object, in which the method is defined, collaborate to accomplish the goal of the method. In addition, any objects (primitive or non primitive OOPS data types), that may be created by the method are also considered to be participants of the collaboration, and have a higher precedence than other collaborating objects”

Among the objects which were received as parameters, or created in the method, a proper subset may be chosen as participants in the collaboration, with a restriction that the object in which the method is defined must be included as a participant. It may be noted that since objects can contain objects and attributes or fields, all contained objects and fields are automatically included in collaboration.

28) Conceptual Processing—Data Sources and Data Containers—Definitions:

28.1) Data Sources: An object which conceptually represents a sequence of data records or images of the object, in some media, is referred to as a Data source. The object must be capable retrieving the next image, and be able to refresh itself with the newly retrieved image. It may be noted that the media need not be sequential in nature.

28.2) Data Containers: An object which conceptually represents one data record or image out of several (one or more) possible data records or images. The object must be capable of retrieving one of the several images it may represent at any particular time, and refresh itself with the newly retrieved image.

29) Conceptual Processing—Collaboration Table: CPR methods may optionally utilize collaboration, and those methods, which intend to use collaboration, must specify the exact nature of the collaborating objects via a table, which is referred to as the Collaboration table. The CPR system generates the method body, when a collaboration table is specified. The exact description of this process is provided in the Operation section.

Each object participating in the collaboration specifies a forward and reverse Interface group, for normal processing. In addition, a forward and reverse Interface group is also specified for error processing. Thus, four CPR interface groups are specified for each object participating in the collaboration. As explained before, an Interface group contains, one or more CPR Interfaces.

The order of execution of the CPR Interface groups, is as given below.

CPR FORWARD NORMAL INTERFACE GROUP,

CPR FORWARD ERROR INTERFACE GROUP,

CPR REVERSE NORMAL INTERFACE GROUP,

CPR FORWARD ERROR INTERFACE GROUP

The objects in the collaboration table are broadly classified as groups of objects, and are identified by a group number, henceforth referred to as the collaboration group number, and a sequence number within the collaboration group.

Collaboration groups, which have sequential group numbers, are considered as a logical unit of execution. The limits of the logical unit are identified by the non existence of the collaboration group numbers (in the collaboration table), before the first collaboration group of the logical unit, and after the last collaboration group of the logical unit.

Default sequence for collaboration groups is the next group number, however, it is possible to branch off to a different collaboration group, based on a condition referred to as the “branch” condition. It may be noted that a branch may be made only into the first collaboration group of a logical unit, branch may not be specified into the middle of a logical unit.

It may be noted that it is possible to specify “null” for a collaboration object.

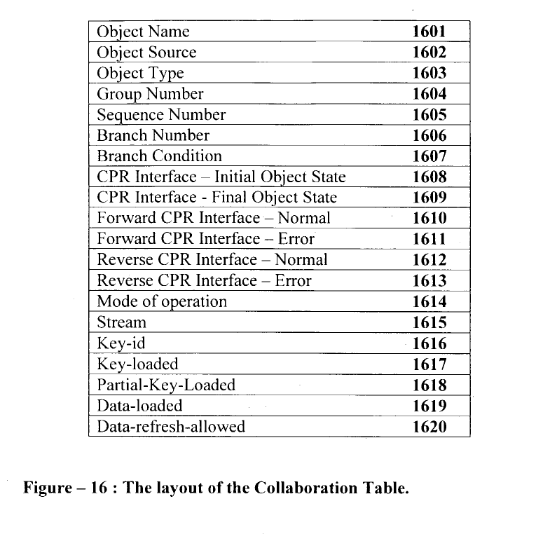

FIG. 16 depicts the Collaboration table, in XML format, and the layout of the Collaboration table is described below.

29.1) Object Name—1601: This field contains the Object name in CPR notation.

29.2) Object Source type—1602: This field contains information on source of the object. It may be noted that the Object may be received as a parameter of the method, or may be created inside the method body, or may be an attribute or field of the Object in which the method is defined.

29.3) Object Type—1603: This field contains information on the type participation of the Object. It may be noted that Objects may participate in Collaboration as “Data Sources” or “Data Containers”.

29.4) Group_Number—1604: This field identifies the collaboration group number.

29.5) Sequence Number—1605: This field identifies the relative sequence number within a collaboration group.

29.6) Branch Number—1606: This field contains a collaboration group number to which processing branches off, depending on a predefined condition (the state of the collaboration Group).

29.7) Branch Condition—1607: This field identifies the state of the collaboration Group, when a Branch to another collaboration group may be made. Valid values and their meanings are,

“R”: After a read operation on the object,

“A”: After executing the forward interface group,

“B”: Before executing the reverse interface group.

29.8) Initial Object State—1608: This field contains a CPR Interface, which validates the state of the Object. This CPR Interface is executed first, to ensure the object is in the required state, before it participates in the Collaboration.

29.9) Final Object State—1609: This field contains a CPR Interface, which moves or takes the Object to the final desired state. This CPR Interface is executed last, after it has participated in the Collaboration.

29.10) Forward Normal Interface Group—1610: This field contains a CPR Interface Group name, which is executed in the forward path of execution of the CPR Interface group.

29.11) Forward Error Interface Group—1611: This field contains a CPR Interface Group name, which is executed if an error is encountered in the forward path of execution of the CPR Interface group.

29.12) Reverse Normal Interface Group—1612: This field contains a CPR Interface Group name, which is executed in the reverse path of execution of the CPR Interface group.

29.13) Reverse Error Interface Group—1613: This field contains a CPR Interface Group name, which is executed if an error is encountered in the reverse path of execution of the CPR Interface group.

29.14) Mode_Of_Operation—1614: This field identifies how the object is used in Collabaration. It may be noted that the mode of operation may be Input, Output or Update, and the values may be “I”, “O”, or “U”. This field is applicable to both data sources as well as data containers.

29.15) Stream—1615: This field is set to ‘Y’, if the underlying object is a stream.

29.16) Key_Id—1616: This field contains a number, which identifies one of the several keys of the underlying object. This field, is applicable to both data sources as well as data containers.

29.17) Key_Loaded—1617: This field contains a flag, which identifies, if the Key is loaded. The values may be “Y” or “N”. This field is applicable to both data sources as well as data containers.

29.18) Partial_Key_Loaded—1618: This field contains a flag, which identifies, if the Key is loaded partially. The values may be “Y” or “N”. This field is applicable to only data sources.

29.19) Data_Loaded—1619: This field contains a flag, which identifies, if the Data is loaded. The values may be “Y” or “N”. This field is applicable to both data sources as well as data containers.

29.20) Data_Refresh_Allowed—1620: This field contains a flag, which identifies, if the Data may be refreshed. The values may be “Y” or “N”. This field is applicable to both data sources as well as data containers. It may be noted that refresh, implies reloading new values into the data fields of the Object.

30) Collaboration Table—Order and Scope of the Objects:

As explained above, objects specified in the collaboration table and objects contained within them are all participants in the collaboration. It may be noted that the entries in collaboration table are grouped together, and there is a strict order both within the collaboration group and between the collaboration groups.

In the absence of a branch group number, all collaboration groups are executed in order. Within each individual collaboration group, the forward CPR interface groups are executed in the order of the sequence number, and then the reverse CPR interface groups are executed in the reverse order of the sequence number. At the end, of the current collaboration group, the next sequential collaboration group is executed.

When a collaboration group number is specified as a Branch, then the Branch Group is executed, at the specified state of the current Group. This process is recursive, and is repeated until the next group number to be executed is not found in the table.

The exact details of the execution are provided in the operation section. The above description is sufficient to illustrate the nature of the execution, and exemplifies the process order among the objects in collaboration and among the CPR interface groups.

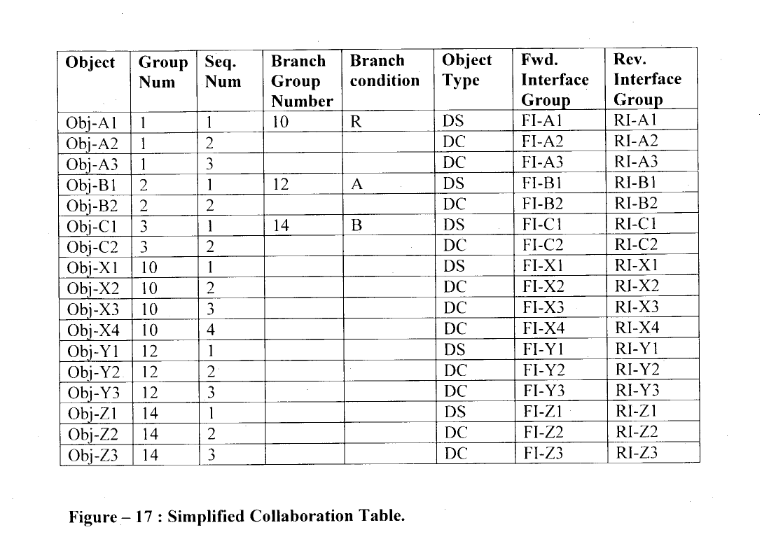

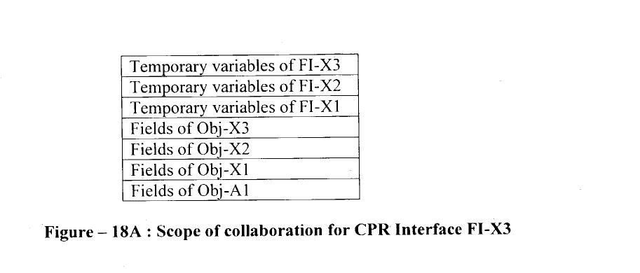

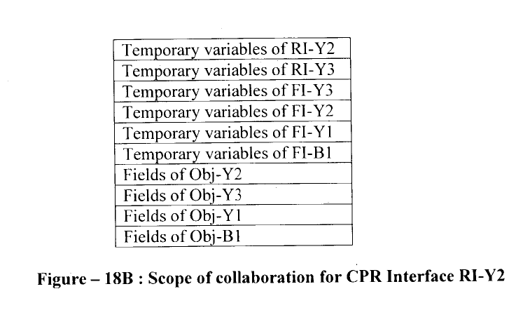

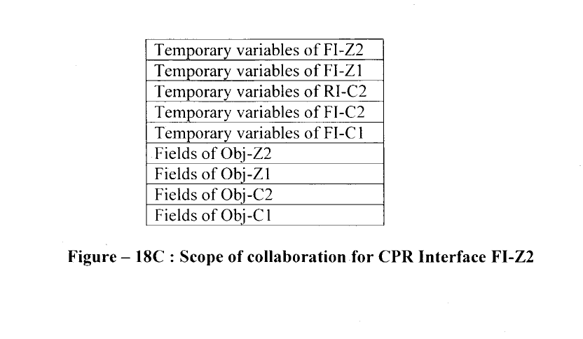

FIG. 17 depicts an extremely simplified Collaboration table, and the scope of various objects in the collaboration table is depicted in FIGS. 18A thru 18C.

31) Conceptual Processing—Collaboration—Client/Server Relationship:

Collaboration implies a client/server relationship, among the collaborating objects as described below.

31.1) The CPR interface groups specified for an object in the collaboration table are executed, relative to that object, and hence the object, which specified the CPR interfaces is considered as a client to the CPR Interface groups. All other collaborating objects in scope of the CPR interface groups are considered as servers.

The temporary variables created by interface groups of other objects may also be in scope of the current interface group, and hence these variables too will participate in collaboration as servers. The storage scheme for the temporary variables is described in a later section.

31.2) The client/server relationship described above is the default behavior, when no functions are specified for the CPR data type. In the presence of a CPR function, the client/server relationship is implemented as per the functions requirements, and there may be a role reversal in the client/server relationship. Hence, it is possible for a CPR function to view the current object as server, and collaboration as clients.

31.3) The default behaviors, with or without CPR functions, described above, may be reversed, whereby, an original client/server relationship is now transformed into a server/client relationship. The role reversal transformation is affected by prefixing the CPR data type with a ‘!’ character, instead of the ‘$’ character. When the CPR data type is specified partially, as “*.cpr-data-type”, then the ‘!’ character must precede the ‘*’ character, as “!*.cpr-data-type”.

31.4) The default behavior of collaboration, not only includes the temporary variables in the collaboration, but assigns a higher priority to temporary variables created by the CPR interfaces over the attributes or fields of the object. Even though, this behavior is useful in most cases, sometimes, it may be necessary to bypass the temporary variables, and look for the associated server or client in the attributes or fields of the objects participating in the collaboration.

CPR provides a facility, for this requirement, and when the prefix of the CPR data type is specified as ‘!!’, the temporary variables are bypassed, and the associated server or client is searched in the objects participating in the collaboration.

31.5) In view of the above description, it may be noted that specifying ‘!!!’, as a prefix for the CPR data type, will cause a role reversal, and will bypass the temporary variables.

32) Conceptual Processing—Data Sources and Data Containers—Details:

Data sources and Data containers must provide read and update methods, so that they may be accessed or updated. The CPR system interacts with the Data sources and Data containers by calling the read and update methods provided by them.

The Data sources and Data containers must implement predefined CPR Interface templates for reading and updating the objects. The methods defined by the CPR Interface templates for the CPR Data Sources, and CPR Data Containers may be described as

{{CPR_Sread1 [,CPR_Sread2, . . . ,CPR_Sreadn], CPR_Update};

{{CPR_Kread1 [,CPR_Kread2, . . . ,CPR_Kreadm], CPR_Update};

where m, and n are integer constants.

The CPR Runtime calls these methods when it wants to perform a read operation. Incidentally the number after “Sread” and “Kread” identifies the key id, specified in the collaboration table entry.

These methods do not contain any code to identify the parameters, since such an approach will make the parameters, and hence the method dependent upon the collaboration. Since Object re-usage is a strict demand, the methods of an object must not be tied to any specific collaboration. This problem is resolved by generating a stub for each method, and the code for the stub is stored in the OOPS class of the forward or reverse CPR Interface Group, whichever is not null. When both the forward and reverse interfaces are null, the object is not read or updated.

The procedure for generating the stub code is described in the operation section, under “translation of CPR Interface groups”.

33) Conceptual Processing—CPR Functions—Detailed Description:

CPR functions are selected from the widely and most frequently used processing patterns, and are classified into various groups, as described below. It maybe noted that this classification is merely to simplify the description, and serves no other purpose.

33.1) Type Cast Function: As explained before, this function assigns the CPR data type specified with the type cast operator to an existing field or temporary variable. If the CPR data type being typecasted is defined with a non collaboration function, then the process stops after the typecasting process described above. However, if the CPR data type is defined with a collaboration function, then the typecasted field participates in collaboration.

In other words, typecasting has higher precedence than the CPR function, which is specified in the CPR data type. The CPR function is applied after the typecast function is applied.

33.2) Arithmetic Functions: These CPR functions are used for addition, subtraction, multiplication, division and related arithmetic operations. As explained before, these operations require two operands, the first operand is selected from the object under consideration, and the second operand is chosen from the collaboration.

These CPR functions are represented as @CPR_ZZZ,

where, ZZZ may be, ADD, SUB, MULT, DIV, REM, QTNT.

33.3) Relational Functions: These CPR functions are used for comparison operations. These operations too require two operands, the first operand is selected from the object under consideration, and the second operand is chosen from the collaboration.

These CPR functions are represented as @CPR_ZZZ,

where, ZZZ may be, EQ, NE, GE, LE, GT, LT.

Incidentally, a special flavor of relational functions is possible, wherein the CPR data type is specified with a trailing symbolic constant and the relation function. In these cases, the relational function is applied to the field value obtained from the object under consideration and the symbolic constant.

33.4) Logical Functions: These CPR functions are used for logical operations. In general, these operations too require two operands, the first operand is selected from the object under consideration, and the second operand is chosen from the collaboration.

These CPR functions are represented as @CPR_ZZZ,

where, ZZZ may be, AND, OR, XOR, NOR, NAND

Negation, is the only logical operator which is applied on to itself, and is represented as @CPR_NEG.

33.5) Data Group Name Function: This CPR function maybe used to identify a Data Group from among several data group definitions provided along with the C-Structure definition.

33.6) Key Function: This CPR function may be used to identify the Key for processing the object. This key is referred to as “Processing Key”, and may be different from the Key, which was used to access the Object.

33.7) Group Functions: These CPR functions are used to process data groups. These operations require two operands, the first operand is selected from the object under consideration, and the second is an internal variable, maintained by the CPR System.

These CPR functions are represented as @CPR_ZZZ,

where, ZZZ may be, COUNT, TOT, AVG, MIN, MAX.

As explained before, the CDT changes when the “TOT” function is applied to a data type, whereas the remaining data group functions preserve the CDT.

33.8) Search Functions: These CPR functions are provided for completeness, and resemble similar functions in prior art. It may be noted that the search argument is determined form the CPR data type, and the list or map to search in, is determined from the extension of the CPR data type.

The variant, @CPR_SRH function, returns a Boolean value and may be used as a State Verifier.

The variant, @CPR_SRH_IDX function returns an integer, which is treated as an index of the underlying data type, contained in the List or Map, which was searched.

The variant, @CPR_SRH_VAL function, searches a map, for the original value, and returns the corresponding mapped value. It may be noted that a map element may be considered as a tupule {a,b}, where a is the original value, and b is the mapped value.

The variant, @CPR_SRH_IDXR function returns a list of integers, where each integer may be treated as an index of the underlying data type, contained in the List or Map, which was searched.

33.9) EVAL Functions: CPR provides two special functions called Eval functions(“Eval” is a short form for Evaluate). The first form is represented as @CPR_EVAL_REXP, and this scans the value of the attribute/field or temporary variable represented by the CPR data type, as per the pattern definition given in the extension of the CPR data type. The second form is represented as @CPR_EVAL_EXP, and in this case, the extension of the CPR data type is a pattern, which may be regarded as an expression or a mini program. Appendix—2 describes a mini language, which may be used to specify expressions or mini programs.

33.10) Event Functions: The description of CPR data types given so far, is sufficient make the dynamic aspect of CPR data types clear. In other words, CPR data types may represent a process specification or action, in addition to data. This idea is explored in great detail in later sections. Since, events automatically follow actions, several functions are provided to process events in CPR.

It may be noted that all event functions are represented with respect to the special CPR data type (default CPR data type) $CPR.DT. All event functions create a new level, and the CPR function $CPR.DT.@CPR_EVENT_END, acts as a sentinel for the event functions.

33.10.1) Generic Event Functions: These functions are provided for processing the positive and negative events which indicate the success or failure of an action.

The event functions are represented as

$CPR.DT.@CPR_EVENT_POS, and

$CPR.DT.@CPR_EVENT_NEG

33.10.2) Data Group Event Functions: These functions are provided to process the Data Group events, which may be represented as

$CPR.DT.@CPR_EVENT_CTLBRK,

$CPR.DT.@CPR_EVENT_GRPITM,

$CPR.DT.@CPR_EVENT_GRPERR

It may be noted that when a control break is detected, the CPR_EVENT_CTLBRK event is generated. If the key field of the object image is same as that of the previous key field read, then the CPR_EVENT_GRPITM event is generated. If an error is encountered in the data group operation, then the CPR_EVENT_GRPERR event is generated.

33.11) Loop Control Functions: These functions are provided to control the “for loops”, which result when the CPR data types corresponds to an index ranges.

The loop control functions are represented as

$CPR.DT.@CPR_BREAK,

$CPR.DT.@CPR_BREAK_POS,

$CPR.DT.@CPR_BREAK_NEG.

$CPR.DT.@CPR_CONTINUE,

$CPR.DT.@CPR_CONTINUE_POS,

$CPR.DT.@CPR_CONTINUE_NEG.

33.12) No Operation Function: This function is used to switch off the default client/server behavior, when a CPR data type is specified in a CPR Interface.

This default behavior may not be required, when an OOPS data type, alias is specified for the CPR data type. Typically, OOPS data types are specified, so that they may be used in an OOPS expression, and in this case, the default behavior is a stumbling block, and can be turned off, by specifying the @CPR_NOOP, function.

A simple example is provided below to illustrate the concept.

<CPR_INTF>

<NAME> MyIntf </NAME>
<FIELDS>

$Sales.Order.$Detail.$Unit.Price.@CPR_NOOP price;
$Sales.Order.$Detail./$Part.Qty.@CPR_NOOP qty;
($Sales.Order.$Detail.$Total.Price)

$CPR.DT.&&“price * qty”.@CPR_EVAL_EXP;

</FIELDS>

</CPR_INTF>

It may be noted that in the above example, price, and qty, do not participate in any updates, but are required to compute the total price.

33.13) Status Functions: These functions may be used to get or set the status of a CPR interface or a CPR Interface group or a collaboration object. Positive integer values are considered as positive status, and negative integer values are considered as negative status.

The get status functions may be represented as

$CPR.DT.$INTF.$cpr-intf-name.@CPR_GET_STATUS; or

$CPR.DT.$INTFG.$cpr-intfg-name.@CPR_GET_STATUS; or

$CPR.DT.$COBJ.$collaboration-object-name.@CPR_GET_STATUS;

The CPR Interface name, CPR Interface group name and the collaboration object name may be omitted, and if omitted, the get status function is applied to the current interface, current interface group and the current collaboration object.

The set status functions may be represented as

$CPR.DT.$INTF.&Vnnn.@CPR_SET_STATUS; or

$CPR.DT.$INTFG.&Vnnn.@CPR_SET_STATUS;

where, & Vnnn, is a symbolic representation for an integer value, an was described before in the symbolic values section.

The @CPR_SET_STATUS function sets the status of the current interface or interface group to the value specified as the integer constant. The absence of the CPR interface name or CPR interface group name may be noted. The collaboration object status may only be retrieved and cannot be set by user.

34) CPR Data Types—Temporary Variables:

Temporary variables may be produced during the execution of CPR Interfaces. The temporary variables may be of fields or attributes of CPR data types defined in the collaboration objects, or of CPR data types defined outside the collaboration data types.

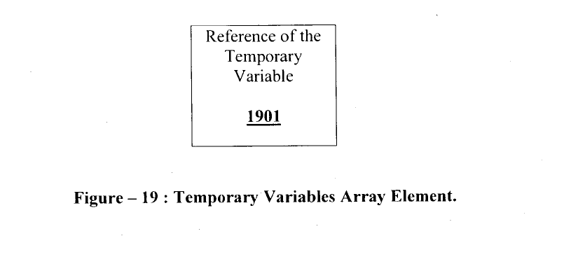

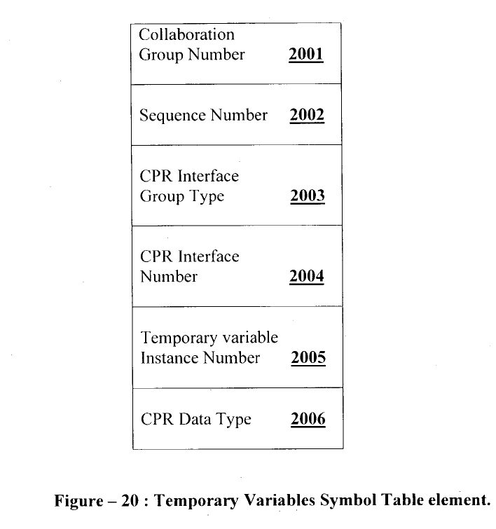

Temporary variables produced are stored in an array, called the temporary variables array. The layout of an entry of the temporary variables array is depicted in FIG. 19. The details of the temporary variables are stored in another array called the temporary variables symbol table. An entry of the temporary variables symbol table is depicted in FIG. 20. Each entry of the temporary variables symbol table array, corresponds to an entry of the temporary variables array and vice versa.

The collaboration group number, the sequence number within the collaboration group, the CPR Interface group type, the CPR Interface number within the CPR Interface group, the CPR data type instance number are stored in the respective fields of the temporary variables symbol table array entry, along with the CPR data type.

The value of the temporary variable is stored in the temporary variable array, at the same index location as that of the temporary variables symbol table array.

35) Conceptual Processing—CPR Methods:

Process requirements are conceptualized by CPR, using the CPR Interface scheme, and the code is automatically generated by the CPR Translator. Typically, methods are seldom needed in CPR, however, there are many situations, in which customization is required, for example, connecting to data bases, and networks, requires specific knowledge and can be performed only in a method. Besides, methods of existing objects, and custom coding, can only be described via methods. In view of these diverse requirements of objects, method definitions are provided in CPR.

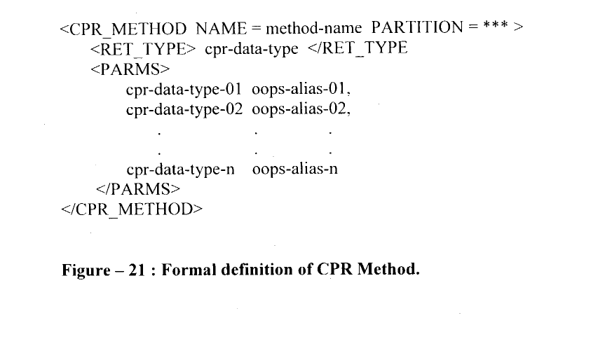

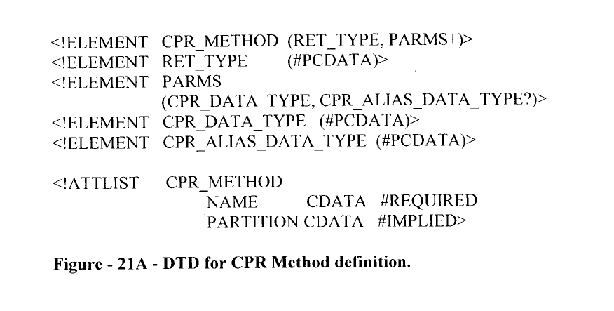

FIG. 21, depicts the generalized scheme for method description in CPR.

FIG. 21A depicts the DTD for a formal definition of the CPR Method. As is evident, the method description comprises of a method name, return type, parameters, and optionally, a method body. A partition within the C-structure may be specified, if the C-structure, is mapped to multiple OOPS objects, so that the OOPS object to which the method belongs may be identified. The method name may be specified as a literal string “constructor”, when a constructor is defined.

CPR methods can be broadly classified into two categories, as described below.

35.1) Methods for which the method body is omitted, but a collaboration table, is specified along with the CPR class definition. The CPR system automatically generates code for these methods.

35.2) Methods for which the method body is provided by users, and the code optionally uses CPR data types. The CPR system translates the CPR data types into OOPS variables.

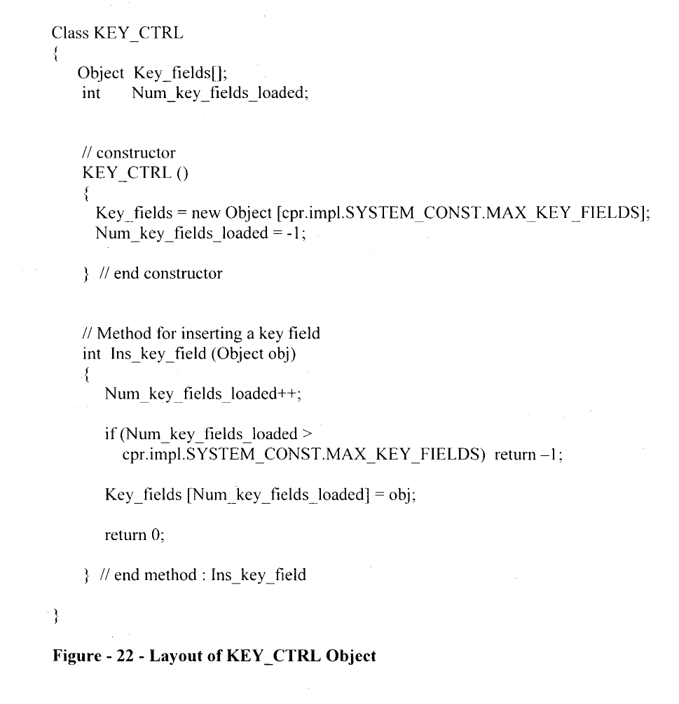

### OPERATION—FIGS. 22 THRU 28

The operation comprises of detailed procedures for translating the CPR object and method descriptions into OOPS object and method descriptions. The specifications for CPR object and method descriptions were illustrated above, in the description part of this document.

The operation is broadly sub-divided into five parts, as described below.

i) Procedure for translating the CPR Object descriptions

ii) Procedure for translating the CPR Method descriptions

iii) Procedure for translating the CPR predefined entities

iv) Run time Operation of the CPR system

v) Algorithms used during the Translation and Runtime operations.

The description of the operation employs several algorithms, which are referred several times in the operation. Hence, these algorithms are listed separately as appendices.

1) Procedure for Translating the CPR Class Description:

The procedure for translating the CPR Class description comprises of parsing the CPR class definition given in the CPR-XML format, and translating the CPR data types of the fields into their OOPS counter parts. It may be noted that the CPR data types are described as nodes and sub-nodes, and these nodes are traversed in order and the complete hierarchical path is obtained, which is translated into an OOPS data type.

The “Algorithm for Locating CPR Classes” (Appendix—3) is used to locate the CPR class description.

The “Algorithm for Translating CPR Data Types” (Appendix—6), is used to translate the CPR data type to an OOPS data type.

If an OOPS alias is specified for the CPR data type, the alias is copied as the field name in the translated OOPS class. If an OOPS alias is omitted, than an oops alias is generated as described in the description with the concatenation “fld_nnnn_”, and the last conceptual tag of the CPR data type, where “nnnn” is the sequential field number within the oops class being generated.

A separate oops class is generated only when the CPR data type being generated corresponds to an oops object and the oops class flag in the Type Translation Library is set to ‘Y’, else the oops class is considered as an field contained in the outer object.

2) Procedure for Translating the CPR Method Descriptions:

As described before in the description, the CPR method may have two forms, and the procedure for translating each of these forms is described below.

2.1) CPR Methods with a Method Body: CPR methods which have a method body are considered as a trivial case. The method parameters, return type, and the CPR data types in the method body are translated, to obtain the OOPS method description. The procedure adopted for the translation is same as the procedure for translating the CPR Object descriptions (fields), and utilizes the “Algorithm for Translating CPR Data Types” (Appendix—6).

2.2) CPR Methods without a Method Body:

CPR Methods without a method body are the crux of the invention. As explained before, CPR methods without a method body are also referred to as “Collaboration Methods”, since they are associated with a Collaboration table. It may be noted that the Collaboration table, which is abbreviated as C-Table, has the same name as that of the CPR method with which it is associated. Method body may not be omitted for Constructors, for which the method name is specified by the literal string “constructor”.

The procedure for generating OOPS method from an empty CPR method specification is as described below. In the procedure, the CPR empty method is referred to as the original method, and the Object (CPR object or the translated OOPS object), in which this method is defined, is referred to as the original object.

2.2.1) For each entry of the Collaboration table, the CPR Interface groups specified within the entry, are translated into OOPS Classes, as described below.

It is extremely important to note that the translation of the CPR Interface groups are carried out in the collaboration order for a collaboration group, and this means, that forward interface groups are translated in forward order and reverse interface groups are translated in reverse order. This order of translation of a collaboration group has great implications, since the temporary variables symbol table which is created as well as searched during translation, is assumed to be in the collaboration order by the process descriptions of the CPR Interfaces.

2.2.1.1) The CPR Interface group and the CPR Interface definitions contained within the CPR Interface group are located by using the “Algorithm for Locating CPR Interfaces” (Appendix—4).

2.2.1.2) The class name of the translated OOPS class for the CPR Interface group is obtained by the following concatenation.

| | |
|---|---|
| Original class name | + |
| Collaboration table name (CPR method name) | + |
| “CO” | + |
| “Group number” | + |
| “Order Number” | + |
| “IG” | + |
| “F/R” | + |
| “N/E” | |

where, “CO” is an abbreviated literal string, for the term “Collaboration Object”,

Group number, is the Collaboration group number,

Sequence number, is the relative sequence number within the collaboration group number,

“IG” is an abbreviated literal string for the term “Interface Group”,

“F/R” is a literal string, which is either “F” for forward Interface groups, and “R” for reverse Interface groups,

“N/E” is the literal string, which is either “N” for Normal interfaces, and “E” for Error interfaces.

The above naming scheme, identifies, each CPR Interface group relative to the Collaboration object. The collaboration object name itself is identified relative to the original class name. The reason for this scheme is due to the implicit storage convention followed, according to which, the original class and the classes generated for the CPR methods share the same name space. In other words, the OOPS classes generated for the collaboration object and the Interface groups are copied into the name space (directory) of the original class.

2.2.1.3) The translation of the CPR Interface Group, comprises of two passes, as described below.

In the first pass, the attributes or fields of the class, a constructor for the OOPS class, a run( ) method to run the CPR Interface group, a helper method get_num_of_Intf( ) to retrieve the number of CPR Interfaces in the CPR Interface group, are generated.

In the second pass, each CPR Interface is translated into an OOPS method of the OOPS class created from the CPR Interface group. The second pass is described in great detail, in the next section.

The rest of this section continues, to describe the first pass, during which code is generated for the methods of the OOPS class identified by the CPR Interface Group.

2.2.1.4) The translated OOPS class, has the following attributes.

class cpr-intf-group-name
{

KEY_CTRL key_ctrl;
DATA_GROUP_CTRL data_group_ctrl;
Int Intfg_status;
Int Intf_status[ ];
// method descriptions not shown

}

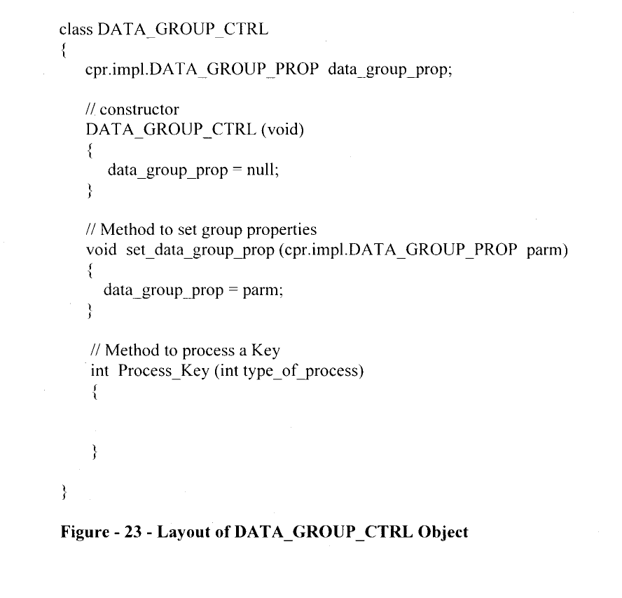

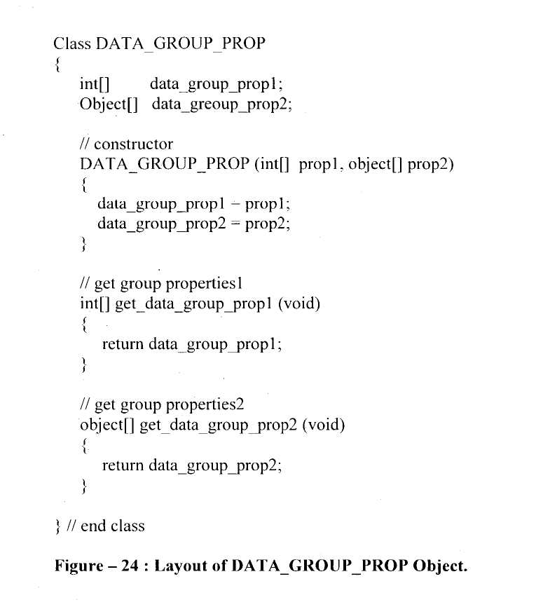

The CPR System utilizes the services of three internal objects called KEY_CTRL, DATA_GROUP_CTRL and DATA_GROUP_PROP for processing data groups. The layouts of these objects are described in FIGS. 22, 23, and 24 respectively.

The field Intfg_status contains the status of the CPR Interface group. The field Inft_status is an array of integers and contains the status of each of the CPR interfaces defined inside the CPR Interface group.

2.2.1.5) The constructor for the cpr-intf-group-name class is generated as described below.

cpr-intf-group-name (void)
{

// initialize key_ctrl and data_group_ctrl objects to
// null
key_ctrl = null;
data_group_ctrl = null;
// initialize cpr interface group status
intfg_status = 0;
// get num of CPR Interfaces defined in the CPR
// Interface group
int n = get_num_of_Intf( );
// create the CPR Interface status array using the
// number of CPR interfaces obtained above
intf_status = new int[n];
// Initialize the CPR Intf status array
for (I=0; I < intf_status.length; I++)

intf_status[I] = 0;

} // end of constructor for cpr-interface-group-name

It may be noted that the code described above, has no knowledge of the number of CPR interfaces, hence a method call to get the number of interfaces is included.

2.2.1.6) The run method is generated by parsing the CPR data types and the CPR Interface definitions, specified in the CPR Interface group.

The translation of CPR data types is described in great detail in the next section.

The CPR Interface definitions are easily identifiable, as they are described as $CPR.DT.$INTF.$cpr-intf-name. The CPR Interface definitions are translated as method calls as shown below, with the help of an example.

A sample CPR Interface may be specified as,

$CPR.DT.$INTF.$My_sample_intf;

The above CPR Interface definition, is translated as,

intf_status[intf-num]=My_sample_intf( );

It may be noted that the CPR interface status returned is stored in the intf status array. The index location “intf-num” of the Interface status array is nothing but the CPR Interface number, within the CPR Interface group.

The translator maintains an internal counter, to keep track of the number of CPR Interfaces encountered so far, and this number also serves to identify the current CPR Interface being translated.

2.2.1.7) The helper method get_num_of_Intf( ), is generated as described below.

int get_num_of_Intf (void)
{

// The number of CPR Interfaces encountered are
// returned to the caller
return NNNN;

}

It may be noted that “NNNN” represents an integer, and specifies the number of CPR Interfaces encountered, during the translation of the CPR Interface Group.

2.2.1.8) In addition to the methods for creating and running the CPR Interface group, the data access stubs for the collaboration object are generated once, either in the forward CPR Interface group or in the reverse CPR interface group, which ever is non-null. If both the forward and the reverse CPR Interface groups are null, then the stub generation is bypassed. The stubs are generated as described below.

If the object type is specified as a “Data source”, and if the mode of operation is “input”, then the stub is generated for the “Sread” method. The method name is obtained by concatenating the string “CPR_Sread” with the index id specified in the collaboration table entry, and the sring “_Stub”. The final method name thus obtained is of the form “CPR_Sread#_Stub”, where ‘#’ is the index id.

The CPR signature of the method name obtained above, is retrieved from the CPR Class description XML document.

For each of the parameters of the method, the collaboration is searched and the matching CPR data type is located from either the temporary variables or the attributes or fields of the collaborating objects. The code required to access the parameters is stored in the stub (method) enclosure being generated. After generating the code required to access all the parameters, the method is invoked with the parameters identified from the collaboration.

For example, the code generated for a collaboration object which is specified as a Data source with Index id 1, may be given as

int CPR_Sread1_Stub (void)
{

// Identify the parameters of the method CPR_Sread1
// from the collaboration, using their CPR data types
// and searching the collaboration as described in the
// algorithm for determining the matching parameter
// in Collaboration (Appendix - 9). This task is performed
// by the CPR Translator, and the code generated will
// look as described below.
OOPS_DT_1 oops_parm_1 = ref. of temp var or field;
OOPS_DT_2 oops_parm_2 = ref. of temp var or field;

| | | | |
|---|---|---|---|
| . | . | . | . |
| . | . | . | . |

OOPS_DT_n oops_parm_n = ref. of temp var or field;
// invoke the CPR Sread1 method
int ret = CPR_Sread1(oops_parm_1, oops_parm_2,...,

oops_parm_n);

return ret;

}

If the mode of operation of the collaboration object is specified as “I-O”, then a stub is generated for the “CPR_Update” method, with the stub name as “CPR_Update_Stub”. The procedure is same as described above for the “Sread” method.

If the mode of operation of the collaboration object is specified as “output” then the stub is generated only for the “CPR_Update” method.

If the object type of the collaboration object is specified as “Data Container”, then the read method invoked is “CPR_Kread”, and the name of the stub generated is “CPR_Kread#_Stub”, where ‘#’ stands for the index id specified in the collaboration table entry.

The CPR runtime only invokes the data access stubs, and it is irrelevant to CPR runtime on how the object implements the read or update methods.

In a similar manner, a stub is generated for the first visible constructor of the current collaboration object, in the CPR XML document. It may be noted that multiple constructors may be defined, and the relevant constructor is identified by comparing the partition name specified on the method definition with the CPR data type of the current collaboration object. The code generated for the stub is stored in the forward or reverse CPR Interface group, which ever is non-null. The stub name is the fixed literal string “CPR_constructor”.

2.2.2) For each CPR Interface group, the CPR Interfaces contained within are translated as methods of the oops class, generated above for the CPR Interface group during its translation. The name of the method generated corresponds to the name of the CPR Interface definition.

Each CPR data type specified in the CPR Interface, may be fully or partially specified. In case of partial specification, the higher level Conceptual tags are omitted and the lower level conceptual tags are prefixed with “*.” as described in the description part of this document.

Identification of the exact CPR data type in the object under consideration, for which the CPR Interface is defined, and matching the CPR data type with a corresponding CPR data type in the objects participating in the collaboration is an important part of the CPR Interface translation. This process utilizes the algorithms “Algorithm for Searching the CPR Data Type” (Appendix—5) and “Algorithm for Determining the Matching Parameter” (Appendix—9).

The CPR interface is traversed from top to bottom, and each CPR data type is retrieved and code is generated for the CPR data type, as described below.

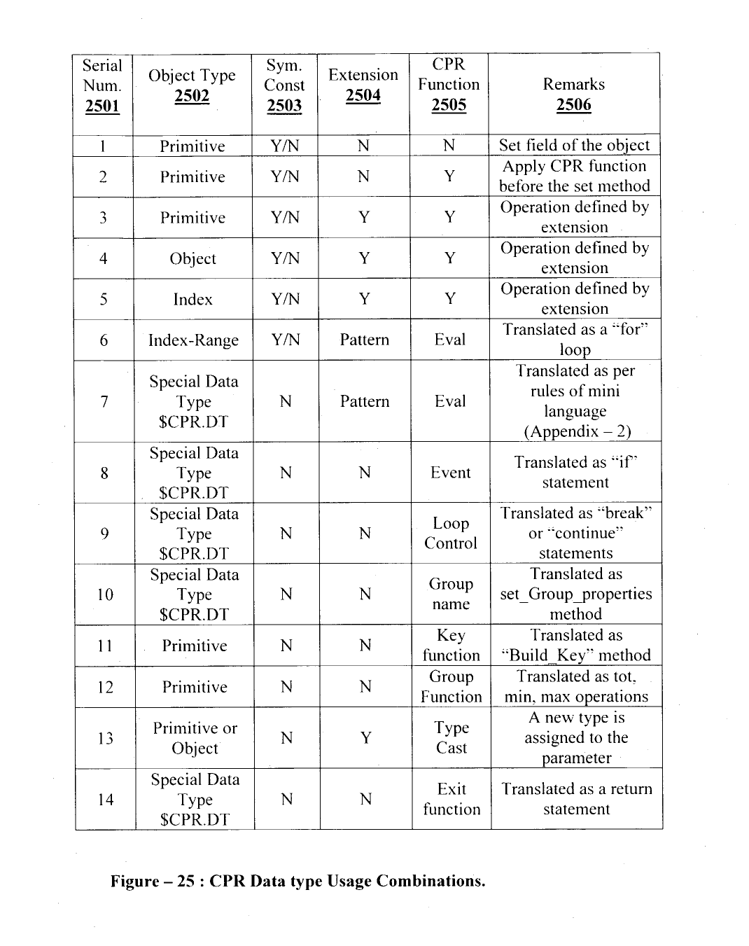

It may be noted that CPR data types may optionally followed by extensions and functions. A full description of all the variants of the CPR data types, may lack clarity, due to the large number of possible combinations. In view of this problem, all possible combinations of extensions and CPR function types are described in the form of a table in FIG. 25, and each case is described with reference to the table entry.

2.2.2.1) Case—01: If the CPR data type alone is specified, with or without symbolic constants but without extensions or functions, then the CPR data type received, as a parameter will replace the corresponding CPR data type of the current collaboration object, for which the CPR Interface is defined. The replacement is typically performed by means of a “set” function, which is provided by the object. It may be noted that in this case, the CPR data type may represent an object or an OOPS primitive data type.

Thus, the code generated may be described as

this.set_Method_Name_ZZZZZ(parm);

where, parm is a temporary variable or a field/attribute name, identified from the collaboration, by making use of the algorithms, “Algorithm for Searching the Temporary Variables” (Appendix—7), and “Algorithm for Searching the Collaboration Objects” (Appendix—8). If a bypass temporary variables operator (!!) is specified, for the CPR data type, then the parm is identified by searching only the collaboration objects as specified in the “Algorithm for Searching the Collaboration Objects” (Appendix—8).

The “set_Method_Name_ZZZZZ” is the OOPS method, which is used to replace the value of the field or attribute identified by the CPR data type.

It may be noted that if the object under consideration is a stream, then the parms are appended to the stream. In this case, the generated code may look like,

this <<parm;

where parm is the field or attribute name identified from the collaboration.

If a role reversal operator is specified as the prefix, and if the parm, identified from the collaboration is located in the temporary variables array, then the code generated may be given as

parm=this.get_Method_Name_ZZZZZ( );

If a role reversal operator (!), is specified as the prefix, and if the parm, identified from the collaboration is located in the collaboration objects, or if the bypass temporary variables operator (!!) is specified, in addition to role reversal, then the code generated may be given as

cobj_ref = collaboration_obj_ref_where_parm_is_found;
cobj_ref.set_Method_Name_ZZZZZ(

get_Method_Name_ZZZZZ( ));

It is extremely important to note that in this case, the CPR data type specified as a parameter in the CPR Interface, must be found in the current collaboration object, as well as the rest of the collaboration.

2.2.2.2) Case—02: If the CPR data type is specified, with or without symbolic constants, and without extension, but with a function, then the CPR data type received, as a parameter and the CPR data type of the object are processed by the CPR function and the result may replace the corresponding CPR data type of the object. It may be noted the result will replace the CPR data type of the object, if the function is an arithmetic function. If the CPR function is a relational function, the result is held in a temporary variable.

The code generated for arithmetic functions, may be given as

this.set_Method_Name_ZZZZZ(

this.get_Method_Name_ZZZZZ( )
op-code
parm);

where, “get_Method_Name_ZZZZZ” is the OOPS method, which is used to retrieve the value of the field or attribute identified by the CPR data type, from the object under consideration, op-code may be any of the standard arithmetic symbols “+, −, *, /, //, %” (where the last two symbols stand for quotient and reminder).

As explained before in case-01, parm is a temporary variable or a field/attribute name, identified from the collaboration, by making use of the algorithms, “Algorithm for Searching the Temporary Variables” (Appendix—7), and “Algorithm for Searching the Collaboration Objects” (Appendix—8). If a bypass temporary variables operator (!!) is specified, for the CPR data type, then the parm is identified by searching only the collaboration objects as specified in the “Algorithm for Searching the Collaboration Objects” (Appendix—8).

The same holds true for all logical functions except the unary negation function. For logical functions, the op-code represents a logical operations such as “AND, OR, XOR”.

In case of unary negation, the code generated my be given as

this.set_Method_Name_ZZZZZ(!parm);

where, “!” stands for the OOPS logical negation symbol.

The code generated for relational functions (in Java), may be given as

intf_action[cur-level] =
if (this.get_Method_Name_ZZZZZ( )

rel-op-code
parm)

?1 : −1;

where, “get_Method_Name_ZZZZZ” is the OOPS method, which is used to retrieve the value of the field or attribute identified by the CPR data type, from the object under consideration, rel-op-code may be any of the standard relational symbols “==, <>, >=, >, <=, <”, and parm is the field or attribute name identified from the collaboration.

It may be noted that if a symbolic constant is specified along with the CPR data type, then the “parm” specified will be equal to the value of the symbolic constant.

If a role reversal operator is specified as the prefix, and if the parm, identified from the collaboration is located in the temporary variables array, then the code generated may be given in an abridged form as

parm=parm op-code this.get_Method_Name_ZZZZZ( );

where the op-code may be an arithmetic or logical symbol described before, the relational op-codes require an “if” statement structuring, as described before when the role reversal operator is not specified.

If a role reversal operator (!), is specified as the prefix, and if the parm, identified from the collaboration is located in the collaboration objects, or if the bypass temporary variables operator (!!) is specified. In addition to role reversal, then the code generated may be given as

cobj_ref = collaboration_obj_ref_where_parm_is_found;
cobj_ref.set_Method_Name_ZZZZZ( parm op-code

get_Method_Name_ZZZZZ( ));

Due to extensive similarities with the code generated for non role reversal case, a full description is omitted.

It is extremely important to note that in this case, the CPR data type specified as a parameter in the CPR Interface, must be found in the current collaboration object, as well as the rest of the collaboration.

2.2.2.3) Case—03: If the CPR data type is specified, with or without symbolic constants, but with an extension, and if the CPR data type corresponds to a primitive OOPS data type, then the extensions and functions may take the following forms.

The CPR data type specified as the parameter is identified from the collaboration, and need not necessarily belong to the current collaboration object. However, role reversal and/or bypass temporary variables may be specified.

2.2.2.3.1) Extension, may be a CPR Predefined entity, such as LIST or MAP. In this case, the CPR data type must also include a search function such as @CPR_SRH or any of its variants.

The generated code (in Java), will look like, cpr.impl.myList.srh(parm);

where. cpr.impl is the name space, where CPR run time implementation code is stored. The object “myList” is an instance of the CPR List Predefined entity. The OOPS function “srh” is the run-time implementation for the CPR search function, and returns a Boolean, indicating the result of the operation.

The remaining variants for the CPR MAPS and LISTS are omitted, since CPR predefined entities are widely known in prior art.

2.2.2.3.2) Extension, may be a CPR Method. In this case, the CPR data type must also include a relational function such as @CPR_CMP_EQ or any other relational function variant.

The generated code (in Java), will look like, primitive-oops-dt x=this.Method_Name(p-1, . . . p-n);

bool c1=if (x rel-op-code parm)

? true:false;

where, primitive-oops-dt is a data type like int, float or char. The parameters p-1 thru p-n are identified from the collaboration by CPR.

2.2.2.3.3) Extension may be a Format. In this case, the original object under consideration must be a stream.

The CPR data type is formatted as per the format specification, and the result is appended to the stream.

2.2.2.3.4) Extension may be a Pattern. In this case, the CPR data type must also include the pattern evaluation function. @CPR_EVAL_EXP or @CPR_EVAL_REXP.

When pattern evaluation function “@CPR_EVAL_REXP” is specified, the pattern itself is broken into tokens consisting of regular expressions and CPR data types. Instead of the exact code, psuedo code is provided to retain clarity.

// get the value of the field from the current
// object
String val = ref-of-temp-var-or-field;
// get prefix of the pattern
string prefix = get_prefix(val);
// get pattern from the list of patterns for the
// CPR data type in the CPR class definition,
// using the prefix.
string pattern = get_pattern(prefix);
break pattern into tokens;
// read the next token
get next token( );
while (token found is true)
{

// init error flag
cpr_error_flag = 1;
if (token == Reg-exp)
{

search variable represented by original
CPR data type for the token, from current
position;
if(search failed)
{cpr_error_flag = 0; break;}
advance pointer in CPR data type to after the
token;

}
if (token != Reg-exp)
{

// token is assumed to be an embedded
// CPR data type
get oops data type of embedded
CPR data type;
read original CPR data type using “C” i/o
format of oops data type of embedded
CPR data type; //typically %d, %f or %s
save value in temporary variable or field of
a collaboration object as per the rules
of collaboration.

}
// read the next token
get next token( );

} // end while
if(cpr_error_flag == 1)
{

intf_action [cur_level] = -1;

}

2.2.2.4) Case—04: If the CPR data type is specified, with or without symbolic constants, but with an extension, and if the CPR data type corresponds to an object (non primitive OOPS data type), then the extensions and functions may take the following forms.

The CPR data type specified as the parameter is identified from the collaboration, and need not necessarily belong to the current collaboration object. However, role reversal and/or bypass temporary variables may be specified.

2.2.2.4.1) Extension may be a Predefined CPR Entity, such as LIST or MAP. In this case, the CPR data type must also include a search function such as @CPR_SRH or any of its variants.

The generated code (in Java), will look like, cpr.impl.myList.srh(parm);

where, cpr.impl is the package name where CPR run time implementation code is stored. The object “myList” is an instance of the CPR List Predefined entity. The OOPS function “srh” is the run-time implementation for the CPR search function. The parameter “parm” for the “srh” function is the field or attribute of the CPR data type or the symbolic constant. It is implicitly assumed that the return type of the “srh” function is Boolean.

It may be noted that the object identified by the CPR data type, is compared with the object stored in the CPR predefined entity (LIST or MAP). The object must be capable of comparison, and must provide an “equals” method as a part of its implementation.

2.2.2.4.2) Extension may be a CPR Method. In this case, the object represented by the CPR data type is used to locate the method. The object for which the CPR Interface is being compiled is referred to as the original object.

The return type of the method may be a complete or partial attribute or field of the original object. If the return type is a partial CPR data type, then it is searched in the original object for the exact CPR data type. The OOPS type for the CPR data type of the return type, must be in agreement with the OOPS return type of the method.

CPR functions may be specified along with the method. In this case, the CPR function is applied to the return type of the method.

If the return type does not belong the current collaboration object or if a no operation CPR function is specified, then the returned value is added to the temporary variables, as described in the “Algorithm for Creating a New Temporary Variable” (Appendix—10).

If the return type belongs to the current collaboration object, then the code generated, is similar to the cases, where the CPR data type is a primitive OOPS data type, with the exception that the return type of the method is now used as the parameter, and the parameter is not identified from the collaboration.

OOPS-dt parm=cpr-dt-object.method(p-1 . . . p-n);

If a CPR function was not specified, then the code generated will be

this.set_Method_Name_ZZZZZ(parm);

If arithmetic CPR function was specified, then the code generated will be

this.set_Method_Name_ZZZZZ(

this.get_Method_Name_ZZZZZ( )
op-code
parm);

where, op-code may be any of the standard arithmetic symbols “+, −, *, /, //, %” (where the last two symbols stand for quotient and reminder).

If relational CPR function was specified, then the code generated will be

bool cl = if

(this.get_Method_Name_ZZZZZ( )
rel-op-code
parm)
? true : false;

where, rel-op-code may be any of the standard relational symbols “==, <>, >=, >, <=, <”.

If logical CPR function was specified., then the code generated will be

this.set_Method_Name_ZZZZZ(

this.get_Method_Name_ZZZZZ( )
op-code
parm);

where, op-code may be any of the standard logical symbols “AND, OR, XOR”.

If the CPR function specifies logical negation, the code generated maybe given as,

this.set_Method_Name_ZZZZZ(!parm);

2.2.2.4.3) Extension cannot be a format, when the CPR data type is an object.

2.2.2.4.4) Extension cannot be a pattern, when the CPR data type is an object.

2.2.2.5) Case—05: If the CPR data type is specified as an index, with or without symbolic constants, and if the index represents a single value, then the extensions and functions may take the following forms. The same considerations described below are also applicable to sub components of an index range.

The CPR data type specified as the parameter is identified from the collaboration, and need not necessarily belong to the current collaboration object. However, role reversal and/or bypass temporary variables may be specified.

2.2.2.5.1) Extension may be a CPR predefined entity, such as a LIST or MAP. In this case, the CPR function must be one of the search variants. The code generated is exactly same as that for a CPR data type, which is mapped to a primitive OOPS data type.

2.2.2.5.2) Extension may be a CPR method. In this case, the CPR function must be one of the relation function variants, and the return type of the method must match the CPR data type of the index. The code generated is exactly same as that for a CPR data type, which is mapped to a primitive OOPS data type.

2.2.2.5.3) Extension may be a format. In this case, the original object under consideration must be a stream. The CPR data type is formatted as per the format specification, and the result is appended to the stream.

2.2.2.5.4) Extension may not be a pattern.

2.2.2.6) Case—06: If the CPR data type is specified as an index, with or without symbolic constants, and if the index represents a range value, then the extensions and functions may take the following forms.

The CPR data type specified as the parameter is identified from the collaboration, and need not necessarily belong to the current collaboration object. However, role reversal and/or bypass temporary variables may be specified.

2.2.2.6.1) Extension cannot be a CPR Predefined entity.

2.2.2.6.2) Extension cannot be a method.

2.2.2.6.3) Extension cannot be a format.

2.2.2.6.4) Extension can be a pattern, and the CPR function @CPR_EVAL_EXP must be specified. The pattern is evaluated as explained in Appendix—2.

The index range is translated as a “for” loop. The code generated may be given as

for (idx = index_start; idx <= index_end; idx++)
{

// for block

}

The code generated for subsequent CPR data types, is included within the “for” loop.

It is important to note that each “for” loop creates a new level, and CPR data types outside of all for loops are at level-0.

2.2.2.7) Case—07: If the CPR data type is specified as the special CPR data type with the expression evaluation functions as

$CPR.DT.&&“my-pattern”.@CPR_EVAL_EXP

then the pattern specified is evaluated as explained in Appendix—2.

2.2.2.8) Case—08: If the CPR data type is specified as the special CPR data type with the generic event functions as

$CPR.DT.@CPR_EVENT_POS or

$CPR.DT.@CPR_EVENT_NEG,

then the code generated may be given as

if (cpr-action-status[cur-level]>0)//EVENT POSITIVE

if (cpr-action-status[cur-level]<0)//EVENT NEGATIVE

It may be noted that like “for” loops, generic event functions create a new level, and all CPR data types described after the generic event function till another generic event function or the sentinel event function, $CPR.DT.@CPR_EVENT_END, are considered to be at one level higher than the current level.

The generic event function $CPR.DT.@CPR_EVENT_END, functions as a sentinel for the other generic event functions. No code is generated for this CPR data type.

The data group events, CPR_EVENT_GRPITM, CPR_EVENT_CTLBRK, and CPR_EVENT_GRPERR, are translated just like generic events and the code generated for these events is described below.

if (cpr-action-status[cur-level]==0)//GPITM

if (cpr-action-status[cur-level]<0)//GRPERR

if (cpr-action-status[cur-level]>0)//CTLBRK

2.2.2.9) Case—09: If the CPR data type is specified as the special CPR data type with a loop control function as

$CPR.DT.@CPR_BREAK or

$CPR.DT.@CPR_CONTINUE any of their variants,

then the code generated for non event based loop control functions, may be given as,

break;

continue;

For the loop control functions which are based on events, the code generated may be given as

if (cpr-action-status[cur-level]>0) break;

if (cpr-action-status[cur-level]>0) continue;

if (cpr-action-status[cur-level]<0) break;

if (cpr-action-status[cur-level]<0) continue;

2.2.2.10) Case—10: If the CPR data type is specified as the Special CPR data type $CPR.DT with the @CPR_DATA_GROUP function, then the extension refers to a CPR Data Group definition. The CPR data type defining the data group must appear as the first CPR data type of the first CPR Interface of the CPR Interface Group.

Typically the CPR Interface is given as,

<CPR_INTERFACE>

<NAME> Sample_Intf </NAME>
<PARMS>

$CPR.DT.
//My-group-name.@CPR_DATA_GROUP;
$My-data-type-1.@CPR_KEY;
$My-data-type-2.@CPR_KEY);

</PARMS>

</CPR_INTERFACE>

It is assumed that the CPR Group “My-group-name” is defined as,

<CPR_DATA_GROUP>

<NAME> My-group-name </NAME>
<PROPERTIES>

- - - - data group property - l - - - -

| | |
|---|---|
| . | . |
| . | . |

- - - - data group property - n - - - -

</PROPERTIES>

</CPR_DATA_GROUP>

The following code (oops method), is generated within the OOPS class identified by the CPR Interface group, when a Data Group definition is encountered. It may be noted that no code is generated within the method identified by the CPR Interface, when a data group definition is encountered. Data Groups are implemented by making use of the OOPS object DATA_GROUP_CTRL Object described previously.

void set_Data_Group_Properties(void)
{

Data_Group_ctrl.Data_Group_properties =

My-data-group-name-properties;

}

It may be noted that My-data-group-name-properties is of OOPS data type “DATA_GROUP_PROPERTIES”.

In the absence of a Data Group definition, default data group properties will be loaded into the Data Group control object, of the CPR Interface Group as shown below

void set Data_Group_Properties(void)
{

Data_Group_ctrl.Data_Group_properties =

Default-data-group-properties;

}

The fact that a data group definition was processed for this CPR Interface group is stored in internal variables of the CPR translator.

2.2.2.11) Case—11: If the CPR data type is specified with the @CPR_KEY function, then several rules and restrictions apply, which were described previously in the description.

The CPR data type specified as the parameter must belong to the current collaboration object. Role reversal/bypass temporary variables operators may not be specified.

When the @CPR_KEY function is encountered in a CPR Interface, the value of the CPR data type is stored in the KEY_CTRL object contained in the CPR Interface group. The instance of the @CPR_KEY function as the index for the key component array of the KEY_CTRL object.

The code generated is illustrated with the following CPR Interface definition, given in the CPR-XML form.

<CPR_INTERFACE>

<NAME> Sample_Intf </NAME>
<PARMS>

$My-data-type-1.@CPR_KEY;
$My-data-type-2.@CPR_KEY);

</PARMS>

</CPR_INTERFACE>

The code generated for the above interface is given below

void Build_Key (void)
{

// Translation for $My-data-type-1.@CPR_KEY
int I = 1; // instance of first @CPR_KEY definition
KEY_CTRL.key_yalue[I] = value of

$My-data-type-1, as an
Object reference;

// Translation for $My-data-type-2.@CPR_KEY
int I = 2; // instance of first @CPR_KEY definition
KEY_CTRL.key_value[I] = value of

$My-data-type-1, as an
Object reference;

} // end Build_Key method

Since OOPS methods have access to the OOPS class definition in which they are defined. CPR Interfaces which are translated as OOPS methods, can gain access to objects, defined in the CPR Interface groups, which are translated as OOPS classes. Thus, KEY_CTRL object defined in the OOPS class of the CPR Interface group can be accessed by the Sample_Intf method. It may be noted that the CPR Interface group nor its translated OOPS class are not shown in this example, and are implicitly assumed.

The CPR data types defined with @CPR_KEY functions, are merely stored in an internal key object. How the key is processed is based on the presence of other elements in the CPR Interface, and Key definition itself is tied to any specific process specification or implementation.

Although the design is versatile, and can handle any specification, currently keys are used only with CPR Data Groups.

After the last @CPR_KEY is processed, the code for the interface is generated, as shown below

int Sample_Intf (void)
{

// call the set_Group_Properties method
set_Group_Properties( );
// call the Build_key method
Build_Key( );
// Process key
data_group_ctrl.group_status =

data_group_ctrl.Process_Key(key_ctrl);

| - - - - | - - - - | - - - - |
|---|---|---|
| - - - - rest of the code to be generated - - - - | | |
| - - - - | - - - - | - - - - |

} // end method Sample_Intf ( to be generated )

The “key_ctrl” and “group_ctrl” objects are from the current CPR Interface Group.

In simple words, the CPR data type with @CPR_DATA_GROUP function is translated into a separate method called set_Data_Group_Properties( ) method. The CPR data types with @CPR_KEY function are all combined and translated into a separate method called Build_key( ).

The method generated for the Interface Sample_Intf( ), calls these methods. The CPR translator remembers the presence or absence of these CPR data types and generates code for these method calls. Thus instead of putting all the code in one methods, the code related to data group properties and building the key is stored in separate methods. It may be noted that since at most one group may be specified for an interface group, there can be only one set_Data_Group_Properties( ) method or Build_key( ) method.

The advantage of this segregation is that the CPR run time can call the Build_key( ), whenever it needs, to check if a control break has occurred or not, without running the rest of the code of the CPR Interface.

2.2.2.12) Case—12: If the CPR data type is specified with the @CPR_TOT, or any of the other Data Group processing functions, then an internal variable is created to store the value.

The CPR data type specified as the parameter must belong to the current collaboration object. Role reversal/bypass temporary variables operators may not be specified.

The code generated for these functions is of trivial complexity, and is describe here for completeness. In the following description “parm” stands for the current value of the CPR data type, “temp-var” stands for the previously computed value, and “count” stands for the data group occurrences processed.

@CPR_TOT: temp-var+=parm;

@CPR_MIN: temp-var=min (temp_var, parm);

@CPR_MAX: temp-var=max (temp_var, parm);

@CPR_AVG: temp-var=(temp-var+parm)/count;

@CPR_FIRST: if (count==1) temp-var=parm;

It may be noted that the internal variables created are stored in the temporary variables array as described in the algorithm “Algorithm for Creating a New Temporary Variable” (Appendix—10).

If a CDT is not specified for the CPR data type, the CPR function is appended to the CPR data type stored in the symbol table, else the CDT is appended to the CPR data type stored in the symbol table. Thus, several totals can be created with different labels (CDTs), and they can be matched back using the same CDT's.

The CPR translator remembers every CPR data type, which is specified with a CPR data group function. After translating the current CPR Interface, an additional method is generated with the concatenation of the CPR Interface name and the string “_Init”. This method is called the “init” method of the CPR Interface, and contains code to initialize the temporary variables created for every CPR data type, which is specified with a CPR data group function. The CPR data types which are type casted with grand total CDT's such as, @CPR_CDT_GCOUNT/GTOT/GMIN/GMAX/GAVG are excluded from this initialization.

2.2.2.13) Case—13: If the CPR data type is specified with a typecast, then if the typecast data type is a CPR data type, a temporary variable is created in the method working storage and the symbol table for the CPR data type, specified as the type cast.

If the typecast data type is a CDT, then, the CDT is appended to the CPR data type, for identification in the collaboration.

The CPR data type specified as the parameter is identified from the collaboration, and need not necessarily belong to the current collaboration object. However, role reversal and/or bypass temporary variables may be specified.

2.2.2.14) Case—14: If the CPR data type is specified as the Special CPR data type, with the @CPR_EXIT function, then the code generated for non event based usage may be given as

//code generated for—@CPR_EXIT return;

For event based Exit functions @CPR_EXIT_POS, and @CPR_EXIT_NEG, the code generated may be given as

//code generated for—@CPR_EXIT_POS

if (cpr-action-status[cur-level]>0) return;

//code generated for—@CPR_EXIT_NEG

if (cpr-action-status[cur-level]<0) return;

2.2.3) After translating the CPR Interface Groups defined inside the collaboration table, the OOPS method is created from the collaboration table, as described below.

2.2.3.1) The return type of the oops method is generated as of type “int”, which is predefined by convention. The reason for this convention, stems from the fact that the status of a CPR Interface and consequently, the status of a CPR Interface group is an “int” data type, and usually takes, −1, 0 and +1 as values. In other words, methods generated from collaboration table may return only an integer. This is not a limitation since parameters passed as object references can be updated by the method.

2.2.3.2) The method name of the oops method is same of the name of the collaboration table.

2.2.3.3) The entries in the collaboration table are traversed, and those entries, which are identified as method parameters by the source type field, are selected from the collaboration table. The object name of the collaboration table entries selected above, are translated to oops data types, to obtain the parameters of the method. The parameters are identified as “parm-1” thru “parm-n”.

2.2.3.4) The other object names specified in the collaboration table, which are not identified as method parameters, are obtained, from the object references of the parameters (parm-1 thru parm-n), or the reference of the original object (commonly referred as “this” object in OOPS).

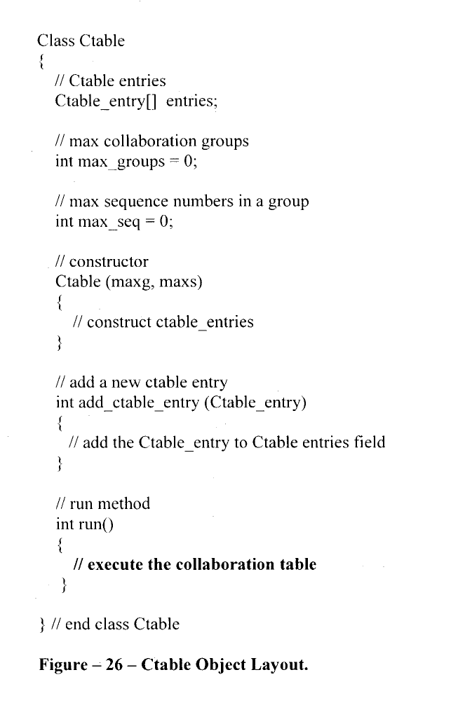

2.2.3.5) The method body utilizes the help of a CPR system object called Collaboration Table object (Ctable object), which encapsulates a lot of the collaboration logic. FIG. 26 describes the layout and methods of the Ctable object. The generation of the method body proceeds as described below.

2.2.3.5.1) The code for creating the Ctable object is generated in the method body as described below

//create Ctable object

Ctable actable=new Ctable(64, 32);

It may be noted that the parameters 64, and 32 passed to the Ctable constructor, are the maximum number of collaboration groups, and the maximum number of sequence numbers within each collaboration group.

These defaults can be changed when the CPR translator is invoked, by sending command line parameters. This is called customization in software design, and is a very common process.

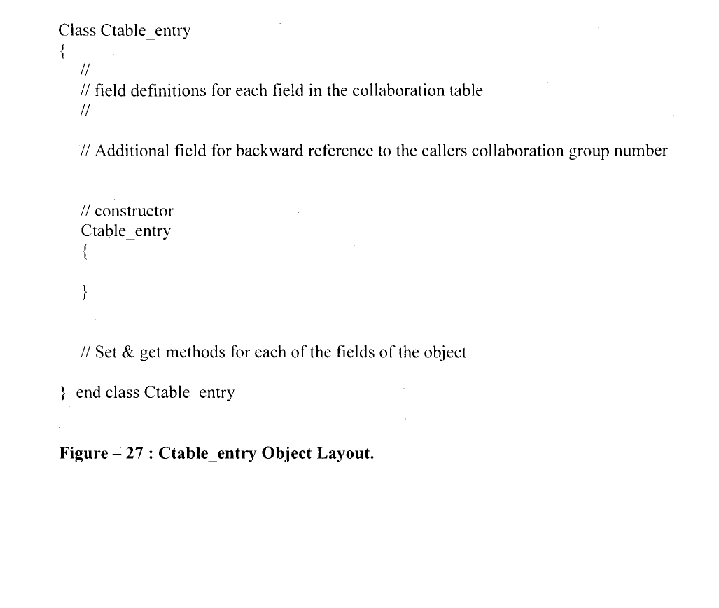

2.2.3.5.2) Each entry of the collaboration table, is converted into an OOPS object called the Collaboration table entry object (Ctable_entry object). A description of the Ctable_entry object is provided in FIG. 27. It may be noted that this object contains all the fields of the collaboration table entry, and an additional field to hold the collaboration group number, of the caller.

During this conversion, the object name is translated to an oops object reference, as explained above.

For each of the CPR Interface group names, a reference of the corresponding oops object is created, using the oops class names generated for the CPR Interface groups. These Object references are stored in the Ctable_entry object.

The other flags and numbers in the collaboration table entry, are parsed and moved to the corresponding fields of the Ctable_entry object. The exact description is omitted as this is too trivial and very simple to implement.

Code is generated to store the caller collaboration group number, if this collaboration group number exists as a branch group in any other entry of the collaboration table, by performing a search of all the entries in the collaboration table. This code is not described, because, collaboration table is described as an XML document, and parsing of XML documents was described in prior art.

The Ctable_entry object is stored in the Ctable object with the help of the method add_Ctable_entry.

Similar code is generated for the other entries of the collaboration table.

At the end of code generation, the method body contains code to create the Ctable object and populate it with Ctable_entry objects created from the data in collaboration table entries.

The code generated for the first entry of the collaboration table may be given as

int method-name (parm-1,...,parm-n)
{

// create a Ctable_entry object for the first
// entry in colloboration table
Ctable_entry actable_entry =

new Ctable_entry( );

// create & set object name in collaboration
// table entry -1, to oops object reference
aCtable_entry.set_Object_ref(

(Object) oops-obj-ref);

// create & set oops object references for the
// CPR Interface groups
aCtable_entry.setNormal_fwd_intf_group(
(Object) new Normal-fwd-intf-group-name( ));
aCtable_entry.setNormal-rev-intf-group(
(Object) new Normal-rev-intf-group-name( ));
aCtable_entry.setError-fwd-intf-group(
(Object) new Error-fwd-intf-group-name( ));
aCtable_entry.setError-rev-intf-group(
(Object) new Error-rev-intf-group-name( ));
// parse other flags and number defined in the
// collaboration table entry and set the
// corresponding field of the Ctable_entry
// object

- - - - this code is not shown - - - -
- - - - as it is very trivial - - - -
- - - - but lengthy, and may - - - -
- - - - in fact diminish the - - - -
- - - - clarity of the presentation - - - -

// add the Ctable_entry to the Ctable
aCtable.add_Ctable_entry(actable_entry);
// Similar code as above is generated for the
// remaining entries in the collaboration table
// At the end, invoke the run method
aCtable.run( );

} // end method_name

Since, this section of the operational description is mainly devoted to describe CPR translation, the exact runtime operation is not provided here.

As stated above, at the beginning of the operational description, a separate section is devoted to explain how all these components work together at runtime.

3) Procedure for Translating the CPR Predefined Entities:

The translation of CPR predefined entities is an extremely simple process, since the predefined entities can easily be represented as simple data structures in OOPS. These predefined entities are actually well established prior art, but were described here to illustrate how CPR can work with such structures, using CPR data types. The CPR predefined entity is described to the CPR system as a CPR-XML document.

The procedure for translating the predefined CPR entity comprises of the following steps.

3.1) If the CPR predefined entity is a LIST, then the items are the list can be of integer, float, double, char, string, or date data types. The specification of an item must be given as Integer(value), Float(value), Double(value), Char(value), String(value), or Date(value).

The translation comprises of generating the list enclosure, so that these items may be assigned as elements to a predefined array, where the predefined array itself is enclosed in an oops class with the same name as the CPR LIST name.

For example, the following LIST definition. In CPR-XML, may be translated as shown below.

<LIST>

<NAME> MyList </NAME>
<ITEMS>

Integer (10);
Float (20.5);
Char (‘A’);
Integer (20);
String (“XYZ”);
Date (“11/30/2002”);

</ITEMS>

</LIST>

The generated code may be given as

class MyList
{

// List items specified in the CPR predefined type
are merely type casted
// as objects and stored in an array, using the list
initialization notation of
// arrays.
static Object List_Items[ ] = { (Object) Integer (10),

(Object) Float (20.5),
(Object) Char (‘A’),
(Object) Integer (20),
(Object) String (“XYZ”),
(Object) Date (“11/30/2002”)

}

// cpr list object to process the list
static cpr.impl.List cpr_list = null;
// method to create the cpr_list object & return
it when required
static get_cpr_list (void)
{
if (cpr_list = = null)
{

// create the cpr_list object and pass List_Items
to the constructor
cpr_list = new cpr.impl.List(List_Items);

}
return cpr_list;

} // end get_cpr_list method

The code generated for the CPR List, utilizes a run time support class called List in the cpr.impl name space. Thus, the list items are converted to an array using the list initialization technique for arrays, and the array is passed to the constructor of the runtime CPR List object. The actual list processing is performed by the runtime CPR List object, which implements all the functions defined for CPR lists such as search, num of elements in list.

3.2) The translation of CPR Maps, Data Groups are very similar. The details are omitted since the CPR predefined entities are prior art, and the List processing described above, serves to illustrate how such data structures may be used by the CPR system.

4) Run Time Support Provided by the CPR System:

The CPR System provides the implementation of the Ctable object, and the run( ) method of the Ctable object provides the required run time support. As explained in the description above, methods for which a method body is not provided, but a Collaboration table is provided are generated by the CPR system. The translation phase of the operation described above illustrated how the code generated for the method translates the collaboration table into Ctable entries.

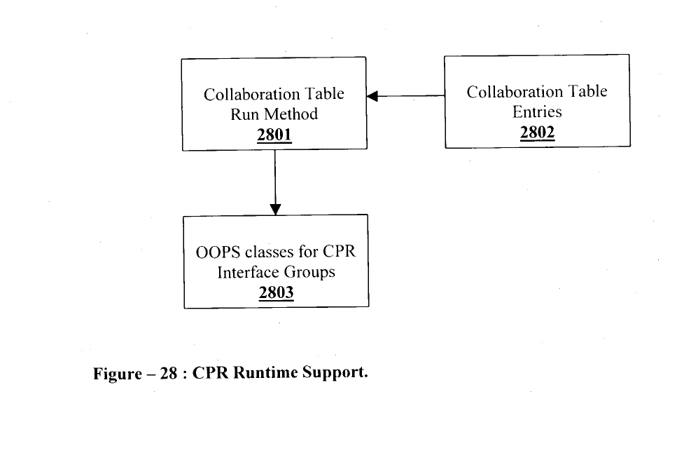

At run time, when the method generated by the CPR System begins execution, it creates the Ctable object, and loads the collaboration table entries into the Ctable and invokes the run( ) method of the Ctable, with values (0, 0) for the collaboration group number, and the collaboration sequence number parameters. Subsequent invocations of the method will bypass loading the Ctable, and directly invoke the run( ) method. The run( ) method of the Ctable object is also described by means of FIG. 28.

The run( ) method begins at the Collaboration group number, and the collaboration sequence number, received as parameters and executes until the next collaboration group number to be executed is not found in the Ctable. The exact operation of the Ctable is described by means of the “Algorithm for the CTable Run Method” (Appendix—11).

The algorithm for the Ctable run( ) method is recursive, and for host languages which do not support recursion, the algorithm needs slight modifications to handle recursive calls. It may be noted that conversion of recursive algorithms to their non-recursive equivalents, is a well-defined operation already established in prior art.

5) Algorithms used during the Translation and Runtime Operations:

The algorithms are described in appendices 3 thru 12, as algorithms are described with respect to paragraph number 1, and may cause confusion, when included in the main document.

Advantages:

The advantage of my invention is that coding is eliminated significantly, and developers can concentrate on the application design rather than on coding.

Conclusion, Ramification, and Scope

Accordingly, the reader will see that my invention is applicable to several object oriented systems and is not limited to any specific implementation. Although the description, may contain many specificities, these should not be construed as limiting the scope of the invention, but as merely providing illustrations of some of the presently preferred embodiments of this invention. The description of the CPR runtime object classes are described are in “java” like language, but this should not mean that this invention is limited to “java” platform.

### REFERENCES

The following references are incorporated by references, into the present application:

1) C How to Program: Second Edition H M DEITEL/P J DEITEL: Prentice Hall: ISBN 0-13-226119-7

2) C++ The Complete Reference: Second Edition Herbert Schildt: McGraw Hill: ISBN 0-07-882123-1

3) A Simplified Guide to Structured Cobol Programming Daniel D McCracken/Donald G Golden: John Wiley & Sons: ISBN 0-471-61054-2

4) The Java Programming Language: Third Edition Ken Arnold/James Gosling/David Holmes: Addison Wesley ISBN 81-7808-148-2

5) Learning XML: First Edition Eric T Ray: O'REILLY: ISBN 81-7366-314-9

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is

1) a procedure for describing “objects” and associated “methods”, of object oriented programming systems (OOPS), as conceptual descriptions, and a system, henceforth referred to as conceptual process redactor (CPR), for translating said conceptual descriptions into OOPS object layouts, and methods, and for providing run time support to the said objects and their methods:

2) The procedure of claim 1, for describing “objects” as conceptual descriptions, further comprises of
2.1) A procedure for describing information as XML tree structures henceforth referred to as Conceptual structures or C-structures, or CPR classes.
2.2) A procedure for naming each node of the said C-structure, wherein, each node name comprises of a plurality of tags or identifiers separated by dots, and is henceforth referred to as a conceptual tag.
2.3) A procedure for defining data types, wherein, each hierarchical path of the said C-structure is referred to as a CPR data type, and comprises of a sequence of conceptual tags. Each of the said conceptual tags, in the said CPR data type are prefixed special characters, which are henceforth referred to as conceptual tag identifiers.

3) The procedure of claim 1, for describing “objects” as conceptual descriptions, further comprises of
3.1) A procedure for describing commonly used data structures like, Lists, maps, and groups, and enumerating their values or properties, as XML documents.

4) The procedure of claim 1, for describing “methods” as conceptual descriptions, further comprises of
4.1) A procedure for describing the various objects received as parameters, contained in the current object (this object) to which the said method belongs, and the objects which may created during the life time of the said method, in the form of a table, henceforth referred to as the collaboration table.

5) The procedure of claim 4, for describing the said objects in the said collaboration table, further comprises of,
5.1) A procedure for classifying the said objects as “data sources” or “data containers”, depending on their storage and refresh behavior. The said objects are referred to as “data sources”, when they conceptually represent a sequence of data records or images, and implement sequential read methods to retrieve the said data records or images. The said objects are referred to as data containers, if they represent a sequence of data records or images, and implement methods to retrieve the said data records or images randomly.
5.2) A procedure for grouping the said objects, such that each group has one and only one data source, but a plurality of data containers. The said group is henceforth referred to as the collaboration group. The said objects in the said collaboration group are assigned sequence numbers, such that the said data source object has the sequence number zero, and the data container objects have sequence numbers starting from 1.
5.3) A procedure, wherein a sequence of the said CPR data types with extensions, and CPR functions, described as an XML document serve as a conceptual process description, and is henceforth regarded as the CPR Interface.
5.4) A procedure, wherein a sequence of the said CPR data types with extensions, and CPR functions, and the said CPR Interfaces, described as an XML document, serve as a conceptual process description, and is henceforth regarded as the CPR Interface Group.
5.5) A procedure for associating conceptual process descriptions with the said objects, wherein each of the said objects in the collaboration table are associated with four CPR Interface groups, wherein, the first CPR Interface groups is referred to as the forward CPR Interface group, the second, is referred to as the forward error CPR interface group, the third, is referred to as the reverse CPR Interface group, and the fourth is referred to as the reverse error CPR Interface group.
5.6) A procedure for associating conceptual process descriptions of the initial and final state of the said objects, as said CPR Interface groups.
5.7) A procedure wherein, a group of said collaboration groups, which are sequentially numbered, are regarded as a logical unit of execution.
5.8) A procedure, whereby a transfer to a separate logical unit may be specified, on the collaboration table entry of the data source, based on the values stored in the fields of the said collaboration table, which are henceforth referred to as “branch group number” and “branch condition” fields. The value of the said “branch condition” field may be “R” to indicate the execution of the said logical unit specified by the “branch group number” field, immediately after reading the said data source object. The value of the said “branch condition” field may be “A” to indicate the execution of the said logical unit specified by the “branch group number” field, after the execution of the forward CPR Interface group of the said data source object. The value of the said “branch condition” field may be “B” to indicate the execution of the said logical unit specified by the “branch group number” field, before the execution of the reverse CPR Interface group of the said data source object.
5.9) A procedure, whereby the forward CPR Interface groups of all the said collaboration objects in the said collaboration group are executed in order, until the end of the said collaboration group is reached, and then, the reverse CPR Interface groups of all the said collaboration objects are executed in reverse order.
5.10) A procedure, to describe the order of the collaboration objects, whereby, the said object of the said collaboration table entry, is said to be in collaboration with said objects in the previous sequence numbers of the current collaboration group, and with said objects of previous collaboration groups, in the said logical unit or of the logical units of the caller.

6) The procedure of claim 1, for translating conceptual descriptions of “objects” and “methods” to oops object layouts and methods, further comprises of
6.1) A procedure, wherein, the said CPR data types of the CPR class are mapped to OOPS data types in an XML document, henceforth referred to as the Type Translation Library. The mapping comprises of the CPR data type, and the Oops data type, and an alias CPR data type and a generate flag, which indicates that a new class definition must be created if the OOPS data type is an object.
6.2) A procedure, wherein, the said CPR class is retrieved and for each CPR data type, the associated OOPS data type is substituted, if the said generate class flag of the Type translation library, is not set to ‘Y’, for any valid prefix of the CPR data type. If the said generate class flag of the Type translation library, is set to ‘Y’, for any valid prefix of the CPR data type, then the translated OOPS data type is copied to a new class definition identified by the valid prefix of the CPR data type.
6.3) A procedure wherein, for each method where the method body is omitted, but the collaboration table is specified, the said CPR Interface groups of the collaboration entries, are translated to OOPS classes, and the said CPR Interfaces contained in the said CPR Interface groups are translated as methods of the OOPS class obtained by translating the CPR Interface group.
6.4) A procedure for storing temporary variables created by method calls, or type cast function or expression evaluation, in a temporary variables array, and storing the associated CPR data type, and the said collaboration group number, sequence number, said Interface group type, said CPR interface nuber with in the said CPR Interface group, and the said instance number of the CPR data type within the CPR Interface, in the temporary variables symbol table
6.5) A procedure for searching the said temporary variables symbol table array, to locate an Instance of the CPR data type.
6.6) A procedure wherein, each CPR data type of the said CPR Interfaces in the said CPR Interface groups are translated to oops code, such that, when no CPR function is specified, or when an arithmetic or logical or relational PCR function is specified, the said object is treated as a client, or recipient of the said CPR data type, and the collaboration is treated as the server, and the matching CPR data type from the said collaboration is used to locate the value of the said CPR data type, and a set method is generated to set the value of the field in the client, when the CPR data type corresponds to an Index range a “for” loop is generated, where the start, end and increment values of the index range are used as the start, end and increment values of the “for” loop.
6.7) A procedure for reversing the roles of the said client and said server of the collaboration, when the said CPR data type, in the said CPR Interface is prefixed with the said conceptual prefix tag ‘!’.
6.8) A procedure for bypassing the temporary variables, when the said CPR data type is prefixed with the said conceptual tag ‘!!’.
6.9) A procedure for generating the code for the said method which is described as conceptual descriptions, wherein, the said collaboration table entries are loaded into a CPR system object henceforth referred to as Ctable object, and during this process, code is generated for the said method, such that new references of the said CPR Interface groups specified for the said collaboration objects are created from the oops classes generated during the prior translation phase for the CPR interface groups.

7) The procedure of claim 1, for providing run time support to the objects and methods generated by the said CPR system, further comprises of,
7.1) A run method, provided by the said Ctable object, which is invoked by the said method, after loading the said collaboration table entries into the said Ctable object.
7.2) An implementation of the run method of the Ctable object, which begins execution with first collaboration group number zero, and sequence number zero, and executes, the said forward and reverse CPR Interface groups of all collaboration objects, in the collaboration group, and then the logical unit, until all the said data source objects in all the said collaboration groups, of the said logical unit are at end of source.
